(19) United States
(12) Patent Application Publication
(10) Pub. No.: US 2004/0177369 A1
(43) Pub. Date: Sep. 9, 2004

(54) Conditional access personal video recorder

(76) Inventor: Glendon L. Akins III, Fort Collins, CO (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/383,130

(22) Filed: Mar. 6, 2003

(51) Int. Cl. H04N 7/16; H04L 9/00; H04N 7/173; H04N 7/167

(52) U.S. Cl. 725/31; 725/25; 725/30; 725/131; 725/151; 380/44; 380/278; 380/282

(57) ABSTRACT

A Personal Video Recorder (PVR) in a subscriber television network receives service instances from a headend of the subscriber television network. The PVR is adapted to provide conditional access to recorded service instances.

### FIELD OF THE INVENTION

This invention relates generally to communications systems, such as subscriber television systems, among others, and more specifically to providing conditional access to recorded service instances.

### BACKGROUND OF THE INVENTION

In the past, subscriber television systems transmitted analog signals from a headend to the subscribers of the system. Today, however, modern subscriber television systems (STS) typically transmit both analog signals and digital signals to the subscribers, and due to technological advances, more and more of the services provided by the operator of a subscriber television system are being transmitted in digital format because, among other things, they require less bandwidth than analog signals and because digital services are of higher quality than analog services.

Modern subscriber television systems are conditional access systems, which provide services only to the subscribers of the systems. In a typical STS, a subscriber has a digital subscriber communication terminal (DSCT) for accessing the provided services. The DSCT is adapted to receive both analog and digital services and provide conditional access to the services.

Many of the digital services are premium services such as pay-per-view (PPV) movies or the like. Subscribers would like the opportunity to record digital services in a personal video recorder (PVR) or the like so that they can access the recorded services at their convenience. However, owners of the digital services do not want subscribers to have the unlimited ability to record the content of the digital services in PVRs because, among other reasons, they do not want the subscribers to have the ability to make illicit digital copies, which due to their high quality could then be sold as bootleg copies. Thus, there exists a need to provide limited recording capabilities to subscribers of a subscriber television system.

### BRIEF DESCRIPTION OF THE DRAWINGS

FIG. 1 is a block diagram of a subscriber television system, such as a cable television system, in which the preferred embodiment of the present invention may be employed.

FIG. 2 is a block diagram of a headend in the subscriber television system broadcasting to a DSCT-PVR.

FIG. 3 is a block diagram of a headend in the subscriber television system.

FIG. 4 is a block diagram of a secure message.

FIGS. 5A and 5B are block diagrams of generating an authentication token and authenticating an authentication token, respectively.

FIG. 6 is a block diagram of a digital subscriber communication terminal-personal video recorder (DSCT-PVR).

FIGS. 7A and 7B are block diagrams of functional components of the DSCT-PVR recording a digital service and accessing a recorded service, respectively.

FIG. 8 is a block diagram of functional components of the DSCT-PVR accessing a recorded service.

FIG. 9 is a flow chart of steps taken in accessing a recorded service.

FIGS. 10A-10C are flow charts of steps taken to determine whether the DSCT-PVR should access a recorded service.

### DETAILED DESCRIPTION OF PREFERRED EMBODIMENTS

Preferred embodiments of the present invention will be described more fully hereinafter with reference to the accompanying drawings in which like numerals represent like elements throughout the several figures, and in which several exemplary embodiments of the invention are shown. The present invention may, however, be embodied in many different forms and should not be construed as limited to the embodiments set forth herein. The examples set forth herein are non-limiting examples and are merely examples among other possible examples.

In one preferred embodiment, a digital subscriber communication terminal (DSCT) includes a personal video recorder (PVR) and the combination of the two is hereinafter referred to as a DSCT-PVR. Before a subscriber can record a digital service in the DSCT-PVR, the DSCT-PVR determines whether the DSCT-PVR is entitled to permit access to the service. If the DSCT-PVR is so entitled, it generates at least one decryptor for decrypting the service and stores the decryptor(s) with the service in a storage device. When a subscriber attempts to access the recorded service, the DSCT-PVR determines whether the DSCT-PVR is still entitled to permit access to the recorded service. If the DSCT-PVR is so entitled, the DSCT-PVR then uses the recorded decryptor(s) to decrypt the recorded service.

In another preferred embodiment of the invention, the DSCT-PVR receives decryption information from the headend along with the digital service and records the decryption information along with the digital service in the DSCT-PVR. When a subscriber attempts to access the recorded service, the DSCT-PVR then determines if the DSCT-PVR is entitled to permit access to the service, and if so, the DSCT-PVR uses the decryption information that was stored with the service to decrypt the recorded service.

In a third preferred embodiment, the DSCT-PVR records a service and decryption information. When a subscriber attempts to access the recorded service, the DSCT-PVR sends a message to the headend of the STS. The headend sends a reply message to the DSCT-PVR and the DSCT-PVR uses the reply message and other information to determine if the DSCT-PVR is entitled to permit access to the recorded service. If the DSCT-PVR is so entitled, the DSCT-PVR uses decryption information to access the recorded service.

It should be noted that digital services extend well beyond movies or television programming or other video/audio video services and that a PVR is adapted to record and play any digital service regardless of the content. For the purposes of this disclosure, a PVR is intended to include personal digital recorders and the like.

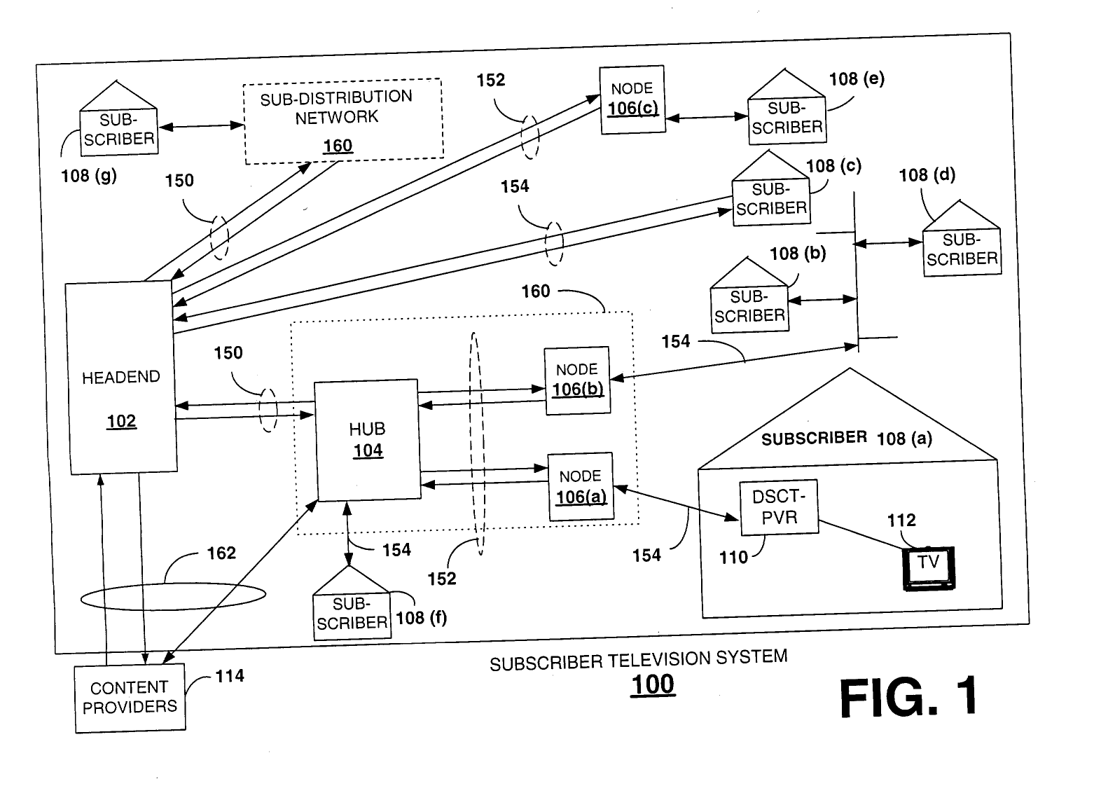

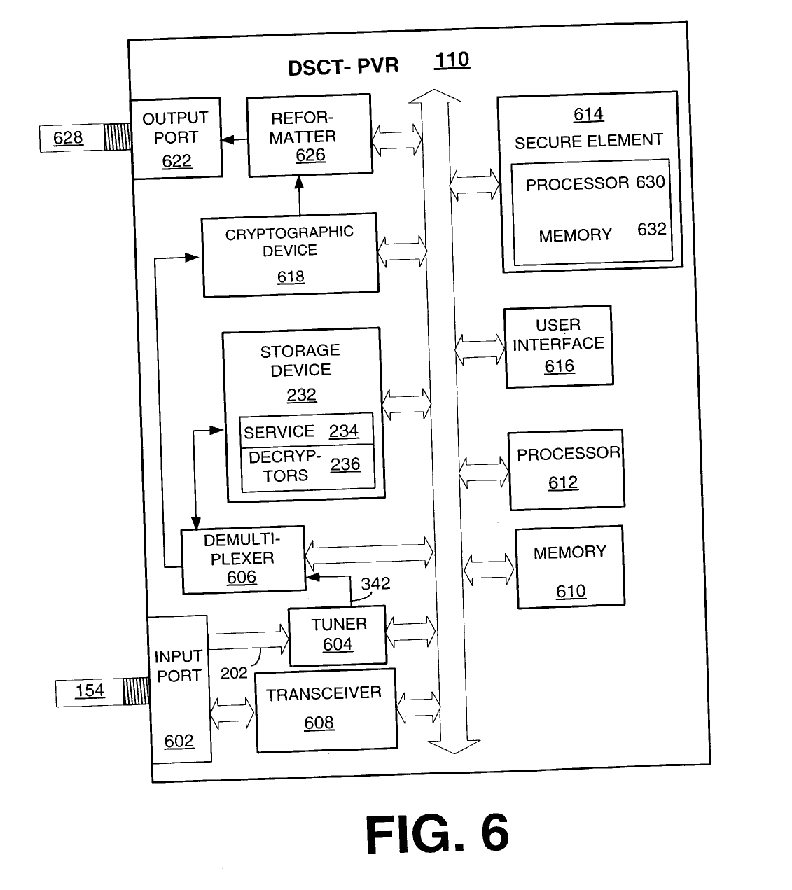

Before explaining a DSCT-PVR, an overview of a modern conditional access subscriber television system (STS), a headend of the STS, and secure authenticated communication between the headend and a DSCT-PVR is provided in FIGS. 1-5, respectively. In FIGS. 6-10 various embodiments of a DSCT-PVR are described.

The logic of the preferred embodiment(s) of the present invention can be implemented in hardware, software, firmware, or a combination thereof. In the preferred embodiment(s), the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present invention includes embodying the functionality of the preferred embodiments of the present invention in logic embodied in hardware or software-configured mediums.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, the process descriptions or blocks in flow charts should be understood as representing decisions made by a hardware structure such as a state machine known to those skilled in the art.

Subscriber Television System Overview

An overview of an exemplary STS, which is also sometimes referred to as a Digital Broadband Delivery System is provided in U.S. Pat. No. 6,157,719, entitled “Conditional Access System”, which is hereby incorporated by reference herein in its entirety. A function of the STS is to: provide interfaces to content providers, service providers and entitlement agents; control access to and the use of the content and services; and to distribute the content and services to subscribers. The content and services are conditionally accessible to subscribers of the STS. In order to access a service, a subscriber must be “entitled,” i.e., a subscriber needs to be authorized to access the service. The content providers and services providers may not want to be in the business of managing entitlements for the subscribers of the STS. In that case, the content and services from the content and service providers are associated with an entitlement agent, and the entitlement agent provides the subscribers with the entitlements for the associated content and services. In addition, the operator of the STS can act as an entitlement agent for service and content providers that don't want to be involved with providing entitlements for services to subscribers.

The subscriber television system offers subscribers of the system services such as, but not limited to, Internet service and telephone service and potentially hundreds of program selections or service instances. Service instances include, but are not limited to, an installment of an audio or visual or audio/visual program. A service instance can be broadcast to all of the subscribers of the subscriber television system, a portion of the subscribers, or an individual subscriber. Service instances include regular programming; special programming such as pay-per-view, and subscriber requested services such as personal television.

Subscriber Television System

Referring to FIG. 1, a subscriber television system (STS) 100 includes, in one example among others, a headend 102, a plurality of hubs 104, multiple nodes 106, a plurality of subscriber locations 108, and a plurality of digital subscriber communication terminals/personal video recorders (DSCT-PVRs) 110. The headend 102 provides the interface between the STS 100 and content and service providers 114, or entitlement agents, such as broadcasters, internet service providers, entitlement agents, and the like via communication link 162. The transmission medium 162 between the headend 102 and the content and service providers 114 is typically two-way, thereby allowing for two-way interactive services such as Internet access via STS 100, video-on-demand, interactive program guides, etc. In the preferred embodiment, the hubs 104 are also in direct two-way communication with the content and service providers 114 via communication link 162 for providing two-way interactive services.

In the preferred embodiment, the headend 102 is in direct communication with the hubs 104 via communication link 150. In addition, the headend 102 is in direct communication with the nodes 106 via communication link 152 and in direct communication with the subscriber locations 108 via communication link 154. Whether or not the headend 102 is in direct communication with subscriber locations 108 is a matter of implementation.

The hub 104 receives programming and other information, which is typically in a protocol such as ATM or Ethernet, from headend 102 via transmission medium 150. The hub 104 transmits information and programming via transmission medium 152 to nodes 106, which then transmit the information to subscriber locations 108 through transmission medium 154. Whether the hub 104 communicates directly to subscriber locations 108 or to nodes 106 is matter of implementation, and in the preferred embodiment, the hub 104 is also adapted to transmit information and programming directly to subscriber locations 108 via transmission medium 154.

In the preferred embodiment, the transmission medium 150 and 152 are optical fibers that allow the distribution of high quality and high-speed signals, and the transmission medium 154 is either broadband coaxial cable or optical fiber. When the communication path from the headend 102 to the DSCT-PVR 110 includes a combination of coaxial cable and optical cable, the communication path is frequently referred to as a hybrid-fiber-coax (HFC) communication path. In alternative embodiments, the transmission media 150, 152 and 154 can include one or more of a variety of media, such as optical fiber, coaxial cable, satellite, direct broadcast, terrestrial digital, Multichannel Multipoint Distribution System (MMDS) or other transmission media known to those skilled in the art. Typically, the transmission media 150, 152 and 154 are two-way communication media through which both in-band and out-of-band information are transmitted. Through the transmission media 150, 152, and 154 subscriber locations 108 are in direct or indirect two-way communication with the headend 102 and/or the hub 104. Typically, when the DSCT-PVR 110 is in satellite, MMDS, or terrestrial-digital broadcast communication with the headend 102, the communication path is one-way from the headend 102 to the DSCT-PVR 110, but in that case, the DSCT-PVR 110 and the headend 102 are typically in two-way communication via a telephone network (not shown).

The hub 104 functions as a mini-headend for the introduction of programming and services to sub-distribution network 160. The sub-distribution network 160 includes hub 104 and the plurality of nodes 106 connected to hub 104. Having a plurality of hubs 104 that function as mini-headends facilitates the introduction of different programming, data and services to different sub-distribution networks of STS 100. For example, the subscriber location 108(b), which is connected to node 106(b), can have different services, data and programming available than the services, data and programming available to subscriber location 108(c), which is connected directly to headend 102, even though the subscriber locations 108(b) and 108(c) may be in close physical proximity to each other. Services, data and programming for subscriber location 108(b) are routed through hub 104 and node 106(b); and hub 104 can introduce services, data and programming into the STS 100 that are not available through the headend 102. In addition, in one preferred embodiment, the hub 104 and the DSCT-PVRs 110 of the hub's sub-distribution network 160 are in two-way communication, which enables the hub 104 to provide real-time conditional access to its DSCT-PVRs 110. Details by which the headend 102 provides conditional access to the DSCT-PVRs 110 of the STS 100 are provided hereinbelow. Because the hub 104 functions as a mini-headend, it can implement the same or similar procedures to provide conditional access.

A DSCT-PVR 110, which is located at a subscriber's premises 108, provides among other things, a two-way interface between the STS 100 and the subscriber. The DSCT-PVR 110 decodes and further process the signals for display on a display device, such as a television set (TV) 112 or a computer monitor, among other examples. Those skilled in the art will appreciate that in alternative embodiments the equipment for first decoding and further processing the signal can be located in a variety of equipment, including, but not limited to, a computer, a TV, a monitor, or an MPEG decoder, among others.

In addition, the DSCT-PVR 110 is adapted to record digital services in a secure fashion so as to prevent illicit/bootleg copying and/or adapted to deny access to a recorded digital service when the DSCT-PVR 110 is not entitled to permit access. If the DSCT-PVR is entitled to permit access to a recorded service, the DSCT-PVR 110 provides the service, responsive to a subscriber request, to a subscriber device such as a television, computer monitor, audio system, MPEG decoder, among others.

Secure communication between the headend 102 and the DSCT-PVRs 110 is preferably accomplished using pairs of asymmetrical keys known to those skilled in the art, such as Rivest, Shamir, & Adleman (RSA) public key encryption technology. Briefly described, an asymmetrical key pair includes a public key, which is distributed to the public, and a private key, which is not distributed. Content that is encrypted with a public key can only be decrypted using the corresponding private key. A message that is signed with a private key is authenticated with the corresponding public key. The headend 102 and the DSCT-PVR 110 can securely communicate after they have exchanged public keys.

The headend 102 includes a database (not shown) that has the public key of each DSCT-PVR 110 in the STS 100. The headend 102 can securely communicate with a particular DSCT-PVR 110 by encrypting the content of a message using the public key of the particular DSCT-PVR 110. Only the particular DSCT-PVR 110 that has the corresponding private key can decrypt the content of the message. The private key of the headend 102 can also sign the message, and in that case the DSCT-PVR 110 uses the public key of the headend 102 to authenticate the message. For details regarding cryptography that a reasonably skilled person would understand see, Bruce Schneier, “Applied Cryptography”, John Wiley & Sons, 1994. The DSCT-PVR 110 can also communicate with the headend 102 using public key-private key cryptography.

In the preferred embodiment, when the DSCT-PVR 110 is manufactured it is assigned a serial number, and it is provided with its own private key-public key pair and with a public key of an access controlling authority. The keys are provided to the DSCT-PVR 110 in a secure manner and stored in a protected memory in the DSCT-PVR 110. The manufacturer of the DSCT-PVR maintains a database that includes the public keys and the serial numbers of each of the DSCTI-PVRs 110 that the manufacturer produces. Each DSCT-PVR 110 in the STS 100 has a unique serial number, and the serial number, which can be the MAC address of the DSCT-PVR 110, is used for addressing messages to the DSCT-PVR 110. The manufacturer provides a copy of the public key and the serial number of each DSCT-PVR 110 in the STS 100 to the operator of the STS 100. In that case, the manufacturer is a key certification authority that certifies to the operator of the STS 100 that a given public key belongs to a specific DSCT-PVR 110. The operator of the STS 100 maintains its database of public keys and serial numbers of each DSCT-PVR 110 in the STS 100.

In the preferred embodiment, the DSCT-PVR 110 is provided with multiple public keys during its manufacture. The DSCT-PVR 110 implicitly trusts these public keys because they were given to the DSCT-PVR 110 during its manufacture in a secure fashion. Consequently, the DSCT-PVR 110 trusts any message that is signed by a private key corresponding to one of these trusted public keys. At least one of the trusted public keys can be replaced by a different public key, which then becomes a trusted public key. To replace a particular trusted public key, the DSCT-PVR 110 receives two messages with a new public key included therein. A different private key signs each one of the two messages, and each private key corresponds to one of the trusted public keys stored in the DSCT-PVR 110. However, the signing private keys do not correspond to the particular trusted public key that is being replaced. The DSCT-PVR 110 uses its trusted public keys to verify that the messages were signed by one of the corresponding private keys, and the DSCT-PVR 110 only replaces one of its trusted public keys when the message is verified.

Before the DSCT-PVR 110 receives and accesses service instances from the headend 102, the DSCT-PVR 110 is registered with the headend 102 and entitled to the service instances. When the DSCT-PVR 110 is connected to the STS 100, it sends a message, which includes the serial number of the DSCT-PVR 110, to the headend 102. The operator of the STS 100 compares the serial number of the DSCT-PVR 110 against its database and registers the DSCT-PVR 110 if the database includes the serial number of the DSCT-PVR 110. Generally, the operator of the STS 100 replaces one of the trusted public keys of the DSCT-PVR 110 with its own trusted public key. This is accomplished by having the manufacturer of the DSCT-PVR 110 digitally sign two messages, each of which include the new trusted public key, for the DSCT-PVR 110 and then sending the two messages to the DSCT-PVR 110.

In one preferred embodiment, the operator of the STS 100 acts as the access controlling authority that controls access to the subscriber network. In another embodiment, among others, the manufacturer of the DSCT-PVR 110 acts as the access controlling authority. There is conditional access authority (CAA) logic implemented in the headend 102 that the access controlling authority uses for controlling access to the STS 100. The conditional access authority sends the DSCT-PVR 110 a secure message such as an entitlement management message (EMM), which is digitally signed by a private key of the conditional access authority. For the purposes of this disclosure, a secure message includes, as a non-limiting example, a message that has been digitally signed by the sender so that the recipient can verify the source of the message and verify that the content of the received message was not tampered with nor corrupted in transmission. The content of a secure message may be encrypted when the sender wants to make the content private or the content can be transmitted without encryption.

In the preferred embodiment, the private key of the conditional access authority corresponds to one of the trusted public keys of the DSCT-PVR 110. The DSCT-PVR 110 authenticates the EMM using the trusted public key of the conditional access authority and acts upon the EMM only if the EMM is authenticated as having come from the conditional access authority. Among other things, the conditional access authority uses EMMs to instruct the DSCT-PVR 110 to allocate a portion of its memory for entitlement information related to a service instance provided by an entitlement agent and to provide the DSCT-PVR 110 with the public key for an entitlement agent.

The CAA establishes an entitlement agent in the DSCT-PVR by having the DSCT-PVR 110 partition its memory such that a portion of the memory is allocated to the entitlement agent, and then providing the DSCT-PVR with the public key of the entitlement agent. Once the entitlement agent is established with the DSCT-PVR, the DSCT-PVR 110 sends its public key to the entitlement agent, after which they can securely communicate using signed and encrypted messages. The entitlement agent is authorized by the CAA to manage the portion of the memory allocated to it and to provide entitlements for services associated with the entitlement agent.

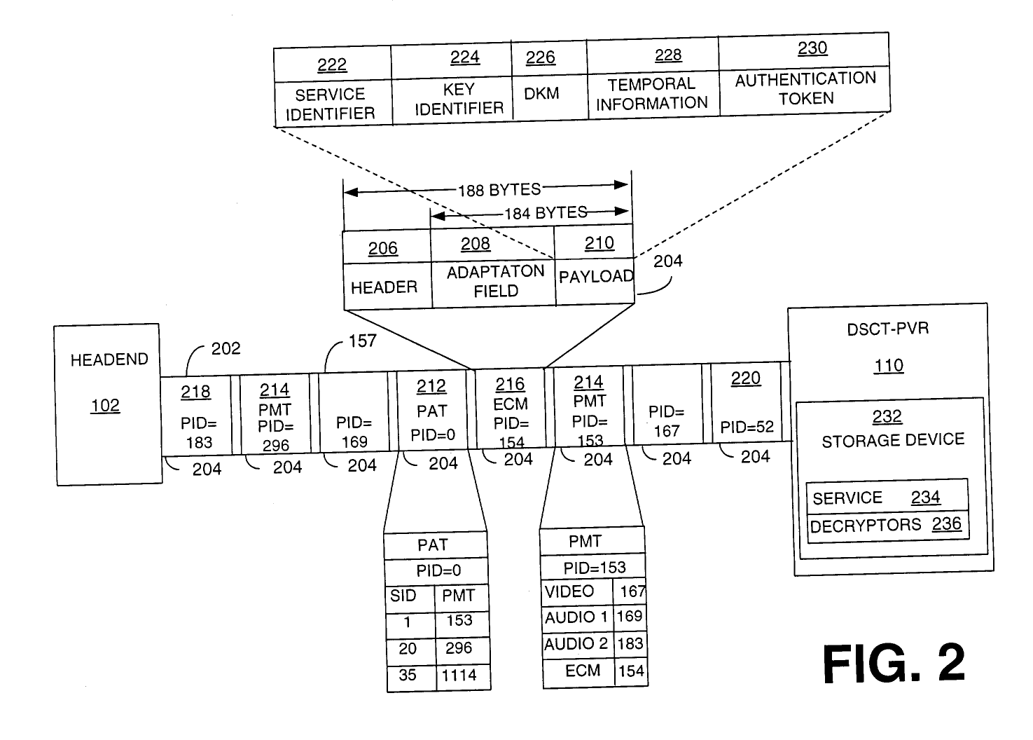

Referring to FIG. 2, the headend 102 transmits a plurality of transport streams 202 to the DSCT-PVR 110 via the communication link 154. Each transport stream is made up of a stream of packets 204. The packets 204 carry information such as system information and digital services.

For exemplary purposes the packets 204 are described in terms of MPEG packets. However, it is to be understood that this is for exemplary purposes only and is a non-limiting example. A brief description of MPEG packets are provided hereinbelow, but further details are provided in the MPEG-1 standards (ISO/IEC 11172), the MPEG-2 standards (ISO/ EC 13818) and the MPEG-4 standards (ISO/ EEC 14496) are described in detail in the International Organization for Standardization document ISO/IEC JTC1/SC29/WG11 N (June 1996 for MPEG-1, July 1996 for MPEG-2, and October 1998 for MPEG-4), which are hereby incorporated by reference.

Briefly described, an MPEG packet 204 is of fixed size, 188 bytes, and it includes a header 206, which is 4 bytes in size and which includes, among other things, a packet identifier (PID) field. The PID field is a 13-bit field that is used to identify packets, and streams of packets. PID values range from 0 to 8,191, inclusive. The PID “0” is reserved for program association tables (PATs). In the STS 100, other PID values are reserved for, among other things, system specific information tables. For example, a “time-message” 220, which carries a time indicator for the current system time has the PID value 52, which in STS 100 could be a reserved PID. Whenever the DSCT-PVR 110 needs to determine the current time of the STS 100, the DSCT-PVR 110 can extract time-messages 220, from the transport stream 202 to determine the current time.

MPEG packets 204 also include an adaptation field 208 and a payload 210. The adaptation field 208 and payload 210 are separately variable in length, but the aggregate length is 184 bytes. In many MPEG packets 204, the adaptation field 208 is set to zero bytes by a field in the header 206 (not shown). The adaptation field 208 is used for, among other things, stuffing the MPEG packet 204 when the size of the payload 210 is less than 184 bytes.

Typically the payload 210 is a portion of a digital service, or a table, or a portion of a table, or other system information, and when the payload 210 carries a portion of a digital service, the portion of the digital service is encrypted. Only legitimate subscribers of the STS 100 have the necessary entitlements and keys for decrypting the payload 210. Selected services such as non-premium television programming or other programming can be carried without being encrypted.

System information such as, but not limited to, tables and messages are also carried in the payload 210 of the MPEG packet 204 and are typically carried without encryption. Among other things, system information includes PATs 212, Program Map Tables (PMTs) 214, Entitlement Control Messages (ECMs) 216, and time-messages 220.

The PAT 212 associates digital services carried by the transport stream 202 with PMTs 214. For example, a given digital service has a service identifier (SID) of 1 and is associated with the PMT 214 having PID 153 and another service having a service identifier (SID) of 20 is associated with the PMT 214 having the PID 296.

The PMT 214 associates elementary streams of a given service to their respective PID values. For example, a given service is identified in the PAT 212 as having the SID 1, and the PMT 214 for that given service has the PID 153. In this example, the given service is a movie or a television program or a video service that is made up of various elementary streams of content such as video, audio 1, audio 2, etc., where the different audio streams carry audio tracts of the service in different languages. Thus, MPEG packets 204 having the PID 167 carry the video stream for the given service, and audio tract 1 for the given service is carried by the MPEG packets 204 having the PID 169. It should be noted that the PID values are uniquely assigned such that no two elementary streams of different services, or-the same service, would have the same PID value. The PMT 214 denoted by PID 153 also associates entitlement control messages (ECM) 216 to a packet having the PID 154. An ECM is a system specific packet that includes, among other things, a service identifier (SID) 222, a key identifier 224, decryption-key-material (DKM) 226, temporal information 228, and an authentication token 230.

The authentication token 230 is a token that the recipient of the ECM uses for, among other things, authenticating the validity of the ECM 216. In the STS 100, messages and other information frequently include authentication tokens so that the messages or other information can be authenticated. Typically, an authentication token for an ECM is a hash digest of at least a portion of the payload 210 of the ECM 216. Whereas, for other messages, an authentication token might be a hash digest that is digitally signed. Digitally signed hash digest and hash digest in general are exemplary authentication tokens and should be considered as non-limiting examples of authentication tokens known to those skilled in the art.

The ECM 216 and the cryptographic system of the STS 100 will be described in detail hereinbelow. However, first a brief description of how in one embodiment, the DSCT-PVR 110 accesses a digital service is given. When a subscriber requests a digital service using a user input device such as a remote control (not shown), the DSCT-PVR 110 extracts the PAT 212 from the transport stream 202 by finding an MPEG packet 204 having PID 0. Next, the DSCT-PVR 110 uses the PAT 212 to determines the PID value of the PMT 214 for the requested service and extracts the correct PMT 214 from the transport stream 202 using that PID value. For example, if the subscriber had requested the given service having SID 1, which for exemplary services is a movie, then from the PAT 212 the DSCT-PVR determines that the correct PMT is carried in packets 204 having the PID 153, which are then extracted from transport stream 202. The DSCT-PVR 110 uses the PMT 214 to determine the PID values of the elementary streams that make up the requested digital service and the PID value of the ECMs for the requested digital service.

Typically, instead of using a single encryption key for an entire service, a digital service is encrypted using encryption keys that are changed multiple times per minute. Thus, if an unauthorized person (pirate) obtains a single decryption key the pirate can only access a fraction of a minute of the service, instead of the entire service. Decryption information is transmitted from the headend 102 to the DSCT-PVR 110 using Key Identifier 224 and DKM 226. If the DSCT-PVR 110 is entitled to permit access to the service, the DSCT-PVR 110 processes the DKM 226 of the ECM 214 is using a key identified by the Key Identifier 224 to generate a single decryption key, control word. Thus, a series of different ECMs 216, each one having a different DKM 226, are multiplexed into the transport stream 202 so as to provide the DSCT-PVR 110 with the necessary information for generating the control words for decrypting the digital service. However, before the DSCT-PVR 110 decrypts the service, the DSCT-PVR 110 uses, among other things, the SID 222 in determining whether the DSCT-PVR 110 is entitled to permit access to the given service.

The DSCT-PVR 110 preferably includes a storage device 232 in which recorded services 234 and decryptors 236 are stored. The decryptors 236 are used for, among other things, determining whether the DSCT-PVR 110 is entitled to permit subscriber access to the stored service 234, and if so, for generating control words for decrypting the recorded service 234.

In a first preferred embodiment of the invention, before a requested service is stored in the storage device 232, the DSCT-PVR 110 determines whether the DSCT-PVR 110 is entitled to access the requested service, and if so, packets of the requested service are stored in the storage device 232 as they are received, and decryptors 234 are generated at the DSCT-PVR 110 and stored in the storage device 232. As will be explained in detail hereinbelow, the decryptors 236 are generated using information included in the ECMs received at the DSCT-PVR 110. When the subscriber wants to access the recorded service 234, the DSCT-PVR 110 determines the current time using the “time-message” 220 and determines whether the DSCT-PVR 110 is entitled to access the recorded service 234. If it is entitled, then the DSCT-PVR 110 uses the decryptors 236 to access the stored service 234.

In another embodiment, when the DSCT-PVR 110 records a service, it does not determine whether it is entitled to record or access the service. The service is simply stored in storage device 232. However, when the subscriber attempts to access the recorded service 234, the DSCT-PVR 110 determines the current time using the “time-message” 220 and determines whether the DSCT-PVR 110 is entitled to access the recorded service 234.

In another embodiment, when a subscriber attempts to access a recorded service 234 the DSCT-PVR 110 sends a secure message to the headend 102. The message includes a random number or other information that is used as a challenge. The headend processes the message and transmits an authenticatable reply message having the current time and the challenge included therein. The DSCT-PVR 110 authenticates the reply message, and if the reply message is determined to be authentic, i.e., it came from the headend 102 and has not been tampered with, then it determines if the DSCT-PVR 110 is entitled to access the recorded service 234. The DSCT-PVR 110 uses the current time included in the reply message as a reference time and does not accept any time-message 220 as being authentic if the time-message has a time that is earlier than the reference time. In this embodiment, the reference time prevents spoofing the DSCT-PVR 110 by using earlier transmitted time-messages 220.

In another embodiment, the DSCT-PVR 110 has both entitlements and rights for recorded services 234. When the subscriber attempts to record a received service, the DSCT-PVR 110 determines whether the DSCT-PVR 110 has the right to record it. In addition to the right to record, other rights include the right to record to an external storage device (not shown) or the right to detached access, i.e., accessing the recorded service 234 when the DSCT-PVR 110 is not in communication with the headend 102 of the STS 100. Another right includes the right to copy the recorded service 234.

In yet another embodiment, the DSCT-PVR 110 has both entitlements and rights, and in this embodiment, the rights of the DSCT-PVR 110 are verified by the headend 102. When a subscriber attempts to record or play a recorded service 234, the DSCT-PVR 110 transmits a message that includes DSCT-PVR rights and a challenge, such as a random number, to the headend 102. The headend 102 determines whether the DSCT-PVR is authorized, i.e., whether it currently has the selected rights, or is authorizable, i.e., the selected rights can be provided to the DSCT-PVR 110, and if so, the headend 102 sends a reply message. The reply message includes the challenge and selected rights for the DSCT-PVR 110. The DSCT-PVR 110 authenticates the reply message, and if the message is authentic, i.e., the message came from the headend 102 and was not tampered with, the DSCT-PVR 110 uses the selected rights included in the reply message. In this embodiment, the challenge and the selected rights are included in the reply message as encrypted content. A subscriber cannot spoof the DSCT-PVR 110 by providing the DSCT-PVR 110 with an expired reply message, because when the DSCT-PVR 110 processes the reply message to authenticate the reply message, the DSCT-PVR 110 would determine the expired reply message is not authentic. Nor can the subscriber edit the content of the reply message to spoof the DSCT-PVR 110, because the content of the reply message was encrypted at the headend 102.

Headend

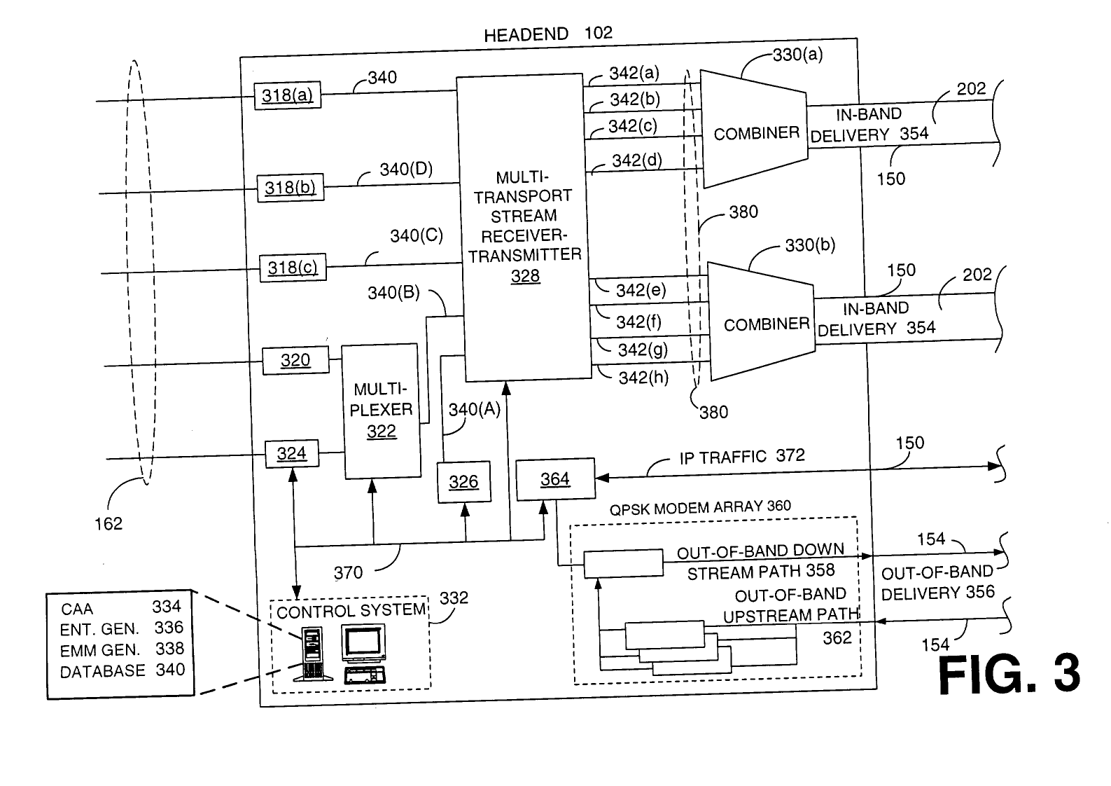

Referring to FIG. 3, in a typical system of the preferred embodiment of the invention, the headend 102 receives content from a variety of input sources, which can include, but are not limited to, a direct feed source (not shown), a video camera (not shown), an application server (not shown), and other input sources (not shown). The input signals are transmitted from the content providers 114 to the headend 102 via a variety of communication links 162, which include, but are not limited to, satellites (not shown), terrestrial broadcast transmitters (not shown) and antennas (not shown), and direct lines (not shown). The signals provided by the content providers, or entitlement agents, can include a single program or a multiplex of programs.

The headend 102 generally includes a plurality of receivers 318 that are each associated with a content source. Generally, content is transmitted from the receivers 318 as a transport stream 340. MPEG encoders, such as encoder 320, are included for digitally encoding content such as local programming or a feed from a video camera. Typically, the encoder 320 produces a variable bit rate transport stream. Prior to being modulated, some of the signals may require additional processing, such as signal multiplexing, which is preformed by multiplexer 322.

A switch, such as asynchronous transfer mode (ATM) switch 324, provides an interface to an application server (not shown). There can be multiple application servers providing a variety of services such as, among others, a data service, an Internet service, a network system, or a telephone system. Service and content providers 114 (shown in FIG. 1) may download content to an application server located within the STS 100 or in communication with STS 100. The application server may be located within headend 102 or elsewhere within STS 100, such as in a hub 104.

Typically, the headend 102 includes a server such as a video-on-demand (VOD) pump 326. VOD pump 326 provides video and audio programming such as VOD pay-per-view programming to subscribers of the STS 100. Usually, the content from VOD pump 326 is provided in the form of the transport stream 340.

It should be noted that the VOD pump 326 is adapted to provide multiple concurrent services to a subscriber location 108, thereby enabling a user of the DSCT-PVR 110 to access one of the services and a user of the client-receiver 122 to access another service. The number of services provided from the headend 102 to a single subscriber location 108 is limited by the bandwidth of the STS 100 and the number or client-receivers 122 at the subscriber location.

The various inputs into the headend 102 are then combined with the other information, which is specific to the STS 100, such as local programming and control information. The headend 102 includes a multi-transport stream receiver-transmitter 328, which receives the plurality of transport streams 340 and transmits a plurality of transport streams 342. In the preferred embodiment, the multi-transport stream receiver-transmitter 328 includes a plurality of modulators, such as, but not limited to, Quadrature Amplitude Modulation (QAM) modulators, that convert the received transport streams 340 into modulated output signals suitable for transmission over transmission medium 380.

In the preferred embodiment, the output transport streams 342 have a bandwidth of 6 MHz centered upon a frequency that is predetermined for each transport stream 342. The frequency for a given transport stream 342 is chosen such that the given transport stream will not be combined with another transport stream at the same frequency. In other words, only transport streams that are modulated at different frequencies can be combined, and therefore, the frequencies of transport streams 342A-D are different from each other, as are the frequencies of transport streams 342E-H. The transport streams 342 from the multi-transport stream receiver-transmitter 328 are combined, using equipment such as combiners 330, for input into the transmission medium 150, and the combined transport streams 202 are sent via the in-band delivery path 354 to subscriber locations 108.

A control system, such as system controller 332, which preferably includes computer hardware and software providing the functions discussed herein, allows the STS system operator to control and monitor the functions and performance of the STS 100. The system controller 332 interfaces with various components, via communication link 370, in order to monitor and/or control a variety of functions, including the channel lineup of the programming for the STS 100, billing for each subscriber, and conditional access for the content distributed to subscribers. The system controller 332 provides input to the multi-transport stream receiver-transmitter 328 for setting its operating parameters, such as system specific MPEG table packet organization or conditional access information among other things.

The system controller 332 includes database 340 and logic for a conditional access authority (CAA) 334, an entitlement generator 336 and an EMM generator 338. The database 340 includes, among other things, the serial numbers and public keys of the DSCT-PVRs 110 of the STS 100. The EMM generator 338 uses database 340 to generate individually addressable EMM templates; to generate EMM templates for multiple DSCT-PVRs 110 and client-receivers 122; and to generate global EMM templates.

Among other things, the CAA 334 is used by the access controlling authority to enable DSCT-PVRs 110 to receive entitlements for service instances. The CAA 334 receives EMM templates from the EMM generator 338 and uses the EMM template to create an EMM. To create an EMM, the CAA 334 includes a message content and an authentication token in the EMM template. The CAA 334 determines whether the message content should be encrypted, and if so, the CAA 334 encrypts the message content using the public key of the recipient of the EMM, which is retrieved from the database 340. The authentication token of an EMM is generally a one-way hash digest of the message content that has been digitally signed by the private key of the CAA 334. In the preferred embodiment, the recipient, i.e., the DSCT-PVR 110, implicitly trusts any EMM that has an authentication token from the CAA 334 because the CAA 334 signs the hash digest with the private key that corresponds to one of the trusted public keys stored in the DSCT-PVR 110.

The DSCT-PVR 110 includes a partitionable memory and the CAA 334 partitions the memory of the DSCT-PVR 110 using EMMs. The DSCT-PVR 110 only partitions its memory in response to EMMs from the CAA 334. The CAA 334 instructs the DSCT-PVR 110 to allocate a portion of its memory to the entitlement generator 336 and provides the DSCT-PVR 110 with the public key of the entitlement generator 336. Once the DSCT-PVR 110 has the public key of the entitlement generator 336, the entitlement generator 336 can securely communicate with the DSCT-PVR 110, and thereby provide entitlements for service instances to the DSCT-PVR 110. The CAA 334 can also disable the entitlement generator 336 by having the DSCT-PVR 110 unallocate the allocated memory. For details regarding allocating and configuring memory in the DSCT-PVRs, see U.S. Pat. No. 5,742,677, Pinder et al., Information Terminal Having Reconfigurable Memory, filed Apr. 3, 1995, which is hereby incorporated by reference in its entirety.

The entitlement generator 336 generates encryption information and the entitlements of the DSCT-PVRs for the service instances. The entitlement generator 336 provides the encryption information to the multi-transport stream transceiver 328, which generates control words therefrom for encrypting the service instances. In the preferred embodiment, the encryption information is a multi-session key (MSK), which has a relatively long life, such as days, weeks, or months. The MSK is transmitted to the DSCT-PVRs 110 in EMMs created by the entitlement generator 336.

The entitlement generator 336 receives EMM templates from the EMM generator 338 for creating EMMs. The EMMs from the entitlement generator 336 also include an authentication token, which is a hash digest digitally signed by the private key of the entitlement generator 336. The hash digest is a digest of the message content. In some situations, the entitlement generator 336 produces a hash digest of at least a portion of the message content and a secret that is known to the recipient. The entitlement generator 336 determines whether to encrypt the message content and when it is determined to do so, it uses the recipient's public key to encrypt the message content. Typical message content in an EMM from the entitlement generator 336 includes MSK, secrets, and entitlements to services.

In an alternative embodiment, the system controller 332 includes a main computer and a plurality of transaction encryption devices, which are coupled to the main computer via a secure link, such as a secure dedicated Ethernet connection. Each transaction encryption device includes a processor and a memory for implementing cryptographic algorithms. In this embodiment, the CAA 334 resides in a first transaction encryption device and an entitlement generator 336 resides in each of the remaining transaction encryption devices. Each one of the transaction encryption devices, which have an entitlement generator, is associated with either an entitlement agent or a content provider. An entitlement agent or content provider can use his or her associated transaction encryption device to provide entitlements to the DSCT-PVRs 110. In this manner, multiple entitlement agents or content providers can provide content to the STS 100, and the operator of the STS 100 can delegate the responsibility of providing entitlements to the entitlement agents or content providers.

Control information such as EMMs and other data can be communicated to DSCT-PVRs 110 via the in-band delivery path 354 or to DSCT-PVRs 110 connected to the headend 102 via an out-of-band delivery path 356. The out-of-band data is transmitted via the out-of-band downstream path 358 of transmission medium 154 by means such as, but not limited to, a Quadrature Phase-Shift Keying (QPSK) modem array 360, or an array of data-over-cable service interface specification (DOCSIS) modems, or other means known to those skilled in the art. Two-way communication utilizes the upstream portion 362 of the out-of-band delivery system. DSCT-PVRs 110 transmit out-of-band data through the transmission medium 154, and the out-of-band data is received in headend 102 via out-of-band upstream paths 362. The out-of-band data is routed through router 364 to an application server or to the VOD pump 326 or to system controller 332. Out-of-band control information includes such information as a pay-per-view purchase instruction and a pause viewing command from the subscriber location 108 (shown in FIG. 1) to a video-on-demand type application server, and other commands for establishing and controlling sessions, such as a Personal Television session, etc. The QPSK modem array 360 is also coupled to communication link 152 (FIG. 1) for two-way communication with the DSCT-PVRs 110 coupled to nodes 106.

The router 364 is used for communicating with the hub 104 through transmission medium 150. Typically, command and control information among other information between the headend 102 and the hub 104 are communicated through transmission medium 150 using a protocol such as but not limited to Internet Protocol. The IP traffic 372 between the headend 102 and hub 104 can include information to and from DSCT-PVRs 110, which are connected to the hub 104.

In the preferred embodiment, the multi-transport stream receiver-transmitter 328 is adapted to encrypt content prior to modulating and transmitting the content. Typically, the content is encrypted using a cryptographic algorithm such as the Data Encryption Standard (DES) or triple DES (3DES), Digital Video Broadcasting (DVB) Common Scrambling or other cryptographic algorithms or techniques known to those skilled in the art. The multi-transport stream receiver-transmitter 328 receives instructions from the system controller 332 regarding the processing of programs included in the input transport streams 340. Sometimes the input transport streams 340 include programs that are not transmitted downstream, and in that case the system controller 332 instructs the multi-transport stream receiver-transmitter 340 to filter out those programs. Based upon the instructions received from the system controller 332, the multi-transport stream receiver-transmitter 328 encrypts some or all of the programs included in the input transport streams 340 and then includes the encrypted programs in the output transport streams 342. Some of the programs included in input transport stream 340 do not need to be encrypted, and in that case the system controller 332 instructs the multi-transport stream transmitter-receiver 328 to transmit those programs without encryption. The multi-transport streams receiver-transmitter 328 sends the DSCT-PVRs 110 the information used to decrypt the encrypted program. It is to be understood that for the purposes of this disclosure a “program” extends beyond a conventional television program and that it includes video, audio, video-audio programming and other forms of services and digitized content. “Entitled” DSCT-PVRs 110 and client receivers 122 are allowed to use the decryption information to decrypt encrypted content, details of which are provided hereinbelow.

The multi-transport stream transmitter/receiver 328 uses the MSK from the system controller 332 to encrypt service instances. The multi-transport stream transmitter/receiver 328 includes an encryptor and a counter that produces a numerical value multiple times per minute. The encryptor uses the MSK to encrypt the counter value to produce a control word. The control word is used by the encryptor as a key for encrypting a portion of the service instance.

The multi-transport stream transmitter receiver 328 includes the counter value in an entitlement control message (ECM), which is multiplexed into the output transport stream 342. Typically, ECMs are transmitted without being encrypted so that the DSCT-PVRs do not have to spend time decrypting the content of the ECM before generating the control word. However, the ECMs include an authentication token that is used for authenticating the message content and limiting access thereto, as will be explained in detail hereinbelow. Typically, the authentication token is a hash digest of the message content and a secret that is shared with the DSCT-PVRs 110, and in that case, the ECM includes an identifier that the DSCT-PVRs 110 uses to identify the shared secret. Only DSCT-PVRs that have the MSK will be able to encrypt the counter value of the ECM to generate the control word that decrypts the service instance.

In the preferred embodiment, the hub 104, which functions as a mini-headend, includes many or all of the same components as the headend 102. The hub 104 is adapted to receive the transport-streams 342 included in the in-band path 354 and redistribute the content therein throughout its sub-distribution network 160. The hub 104 includes a QPSK modem array (not shown) that is coupled to communication links 152 and 154 for two-way communication with DSCT-PVRs 110 that are coupled to its sub-distribution network 160. Thus, it is also adapted to communicate with the DSCT-PVRs 110 that are coupled to its sub-distribution network 160, with the headend 102, and with the content providers 114.

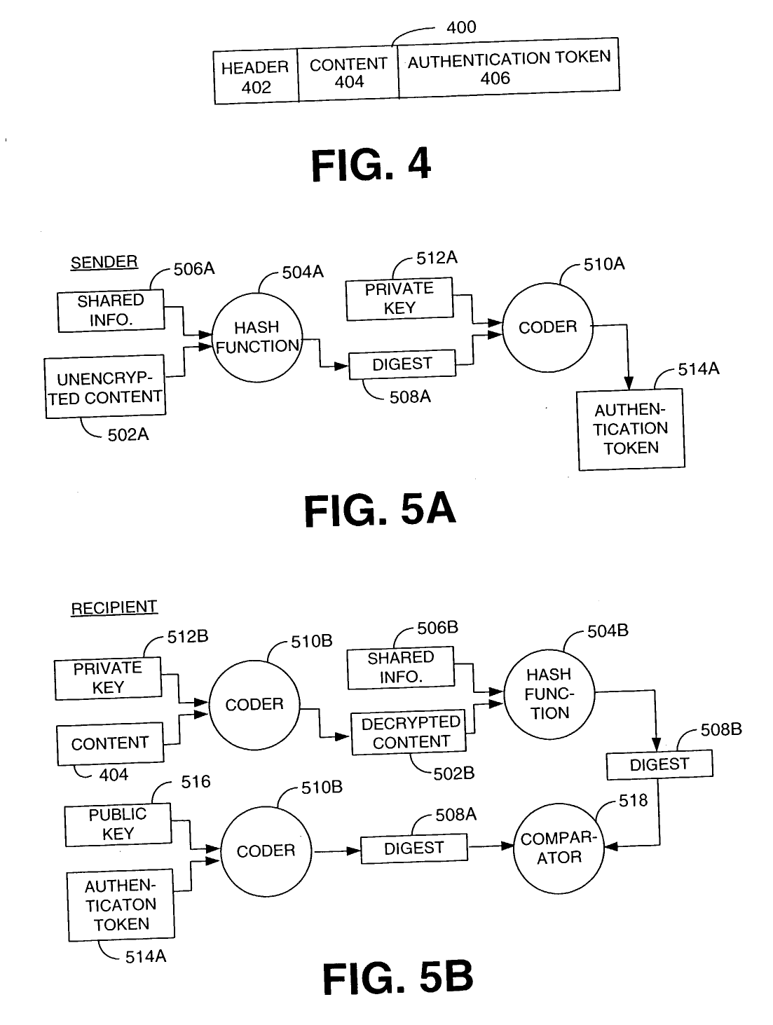

Refer to FIG. 4, a secure message 400 includes a header 402, content 404 and an authentication token 406. Messages such as EMMs, which are used to provide entitlements, rights, keys, and other cryptographic information of the STS 100 are generally transmitted from the headend to the DSCT-PVR 110 as secure messages 400. They are considered to be secure messages because the recipient of the message can determine that the message came from the purported sender and that the received content is the same as what the sender transmitted, i.e., the content was not corrupted during transmission and/or that the content was not tampered with. In addition, the content is generally encrypted so as to protect the privacy of the content.

The header 402 includes address information of the purported sender and the recipient. Some messages are broadcast to some or all of the DSCT-PVRs 110 in the STS 100, and in that case, the recipient address is a global address.

The content 402 is the information that the sender wishes to convey to the recipient. The information can include public keys of public key-private key pairs, multi-session keys (MSKs), secrets, entitlements, rights, and other information. Typically when the message 400 is being sent to a single DSCT-PVR 110, the content 404 includes encrypted content, which was encrypted using the public key of the recipient, and unencrypted content, which the recipient uses to identify a decryption key for decrypting the encrypted content. Only the intended recipient/DSCT-PVR 110 can decrypt the content because only the intended recipient/DSCT-PVR 110 has the private key for decrypting the encrypted portion of content 404.

The authentication token 406 is a digitally signed digest of at least a portion of the content 404. Typically, the hash digest includes as input a shared secret that is shared between the sender and the recipient.

In FIGS. 5A through 5C, objects (inputs and outputs) are depicted as rectangles and functions are depicted as circles. The system controller 232 includes the necessary logic for implementing the functions illustrated in FIGS. 5A through 5C, as does the DSCT-PVR 110. Refer to FIG. 5A, which illustrates the generation of an authentication token 514A by a sender, unencrypted content 502A is input into a hash function 504A along with shared secret or shared information 506A. The shared information 506A is information that the recipient of the secure message 400 has already been provided with in a previous secure message or by other means. Prior to transmitting the secure message 400, the unencrypted content 502A is encrypted and then included as at least a portion of the content 404 of the secure message 400.

The hash function 504A generates a hash digest 508A of the unencrypted content 502A and the shared information 506A. The hash digest 508A is then digitally signed (or coded) by a coder 510A using a private key 512A of a private key-public key pair belonging to the sender of the message 400. The output of the coder 510A is a digitally signed hash digest, which is also referred to as an authentication token 514A.

For the purposes of this disclosure a hash function is a one-way hash function, which is an operation where input is run through some mathematical operations to produce an output, the hash digest, which is a fixed length and which is probably unique. The hash digest has at least two properties: (1) determining the input to the hash function, given the hash digest, is virtually impossible or at least computationally difficult; and (2) a hash digest produced from a given input is essentially unique. In other words, the probability that two different inputs will result in the same output is extremely small. All of the hash digests discussed in this disclosure are generated from one-way hash functions.

Refer to FIG. 5B, when a recipient receives a secure message 400, the recipient reverses the process illustrated in FIG. 5A. The recipient first decrypts the encrypted content 404 using the recipient's private key 512B. A coder 510B, which can encrypt and decrypt, and sign and unsign (code and decode) objects, decrypts the encrypted content 404 and outputs decrypted content 502B. Typically, the decrypted content 502B includes a shared secret specifier, which identifies for the recipient the shared information 506A that was used in creating the digest 508A. The recipient uses the shared secret specifier to identify and retrieve “shared” information 506B, which is equivalent to the shared information 506A of the sender.

A hash function 504B generates a hash digest 508B using the shared information 506B and the decrypted content 502B as inputs.

Next, the recipient provides the coder 510B with the received authentication token 514A. When the coder 510A signed the digest 508A using the private key 512A, it converted the hash digest 508A from a first value to a second value. When the coder 510B processes the authentication token 514A with the public key 516, it converts the authentication token 514A back into the hash 508A, i.e., it processes the second value back to the first value, so long as the public key 516 is the public key for the private key 512B.

A comparator 518 receives the digest 508A, which was produced by the sender, and the digest 508B, which was produced by the recipient, and compares the two digests. If the digests 508A and 508B are the same, then the secure message came from the purported sender and the content has been neither corrupted nor tampered with, i.e., it is authentic.

DSCT-PVR 110

Referring to FIG. 6, the DSCT-PVR 110 includes an input port 602, tuners 604, a demultiplexer 606, a transceiver 608, a memory 610, a processor 612, a secure element 614, a user-interface 616, a cryptographic device 618, an output port 622, the storage device 232, and a reformatter 626.

The DSCT-PVR 110 is adapted to receive in-band and out-of-band communication at the input port 602, and among other things, adapted to communicate with the headend 102 using the transceiver 608; receive services and record selected services in storage device 232; play recorded services 234 using the stored decryptors 236; and provide services to a subscriber device such as the TV 112 coupled to the DSCT-PVR 110 (see FIG. 1) via a communication link 628 extending from the output port 622.

The DSCT-PVR 110 is adapted to enable a subscriber to selectively record services and/or selectively play back recorded services. When the subscriber wants to record a service, the subscriber uses a user-input device (not shown), such as a remote control, to provide commands to the user interface 616. The processor 612 implements logic stored in memory 610 for recording and playing back recorded services. The subscriber is presented with a menu of programming selections for recording future or current services and for playing back recorded services 234. The programming/play menu is provided to the subscriber on a user display device, such as the television 112, and can be similar to how a user programs a current VCR.

The user-interface 616 can be, among other things, a keypad, an infrared receiver, or other interface known to those skilled in the art through which the user enters commands, such as selecting a “user-channel” for viewing a selected service instance. It is important to remember that a “user-channel” is not a conventional television channel. A conventional television channel in a cable television system is a 6 MHz band (which carries one analog program) centered on a particular frequency. However, today a “user-channel” can conceptually correspond to a service instance or a string of service instances in the preferred embodiment of the present invention. Frequently, multiple service instances are multiplexed together in a transport stream, and the transport stream is RF modulated and transmitted in a 6 MHz band. Thus, a single 6 MHz band carries multiple service instances or user-channels. When a user changes programs or service instances by selecting a new user-channel, the new user-channel and the old user-channel might be carried in the same 6 MHz band or in different 6 MHz bands. So it is important to distinguish between a conventional channel and a user-channel. It is to be understood user-channel represents one type of communication channel. Communication channels include, but are not limited to, communication signals that are separated by: frequency, which is generally referred to as frequency-division multiplexing (FDM); time, which is generally referred to as time-division multiplexing (TDM); and code, which is generally referred to as code-division multiplexing (CDM).

The transceiver 608 receives out-of-band communication 358 from input port 602. The out-of-band communication data includes among other things system tables and messages including secure messages 400 such as EMMs. EMMs are sent to the secure element 614 for processing and the system tables are stored in memory 610. The system tables are stored in memory 610 and include encryption tables, which identify, among other things, whether a program is encrypted or not. System tables are prepared by the system controller 332 and transmitted to the DSCT-PVR 110 via in-band or out-of-band communication paths.

The processor 612 receives the user-input from the user-interface 616 and determines the frequency band that contains a selected user-channel. Generally, the multiplexed service instances are in the form of MPEG programs. In that case, the processor 612 consults system information tables, which are stored in memory 610, to determine the frequency band of the selected user-channel and instructs the tuner 604 to tune to the desired frequency band.

The tuner 604 receives in-band communication from input-port 602, which is coupled to the transmission medium 154. In response to instructions from the processor 612, the tuner 604 tunes to the specified frequency band. When the specified frequency band carries an analog signal, the analog signal is provided to the output port 622. However, when the specified signal carries a stream of digital packets, the transport stream 342 is provided to the multiplexer/demultiplexer 606.

The multiplexer/demultiplexer 606 receives the transport stream 342 from the tuner 604 and extracts the PAT (PID=0) from the received transport stream. The processor 612 uses the PAT to determine the PMT for the selected user-channel and uses the PMT to determine the PID values of the elementary streams that make up the program carried in the selected user-channel. The multiplexer/demultiplexer 606 extracts the elementary streams of the service carried in the user-channel and sends the elementary streams to the cryptographic device 618 for immediate access by the subscriber. However, if the DSCT-PVR 110 is operating in record mode, the multiplexer/demultiplexer 606 sends the elementary streams to the to the storage device 232.

In one preferred embodiment, when the DSCT-PVR 110 is operating in record mode, the multiplexer/demultiplexer 606 receives decryptors 236 from the secure element 614. The multiplexer/demultiplexer 606 multiplexes the decryptors 236 with the elementary streams that make up the service being recorded and provides the elementary streams and the decryptors 236 to the storage device 232. In another preferred embodiment, when the subscriber is recording a service, the multiplexer/demultiplexer 606 sends the elementary streams that make up the service and ECMs associated with the service to the storage device 232, and in that case, the ECMs are decryptors 236.

If the subscriber is not recording the service, but is instead presently accessing the service, the processor 612 uses the encryption table stored in memory 610 to determine whether the elementary streams are encrypted. When the elementary streams are encrypted, the cryptographic device decrypts them using decryption information, control words, from the secure element 614. Elementary streams that are not encrypted pass through the cryptographic device 618 to the reformatter 626.

The secure element 614 is used for, among other things, providing the cryptographic device 618 with the control words used for decrypting the selected service instance. It is important to note that in the conditional access system of the STS 100 the DSCT-PVR 110 might not be able to access a selected service instance even though the DSCT-PVR 110 has the necessary keys used for decrypting the selected service instance. In other words, in addition to having all the keys used in accessing the selected service instance, the DSCT-PVR 110 must be “entitled” to access the selected service instance. The DSCT-PVR 110 receives entitlements for service instances from the Entitlement Generator 336 of the system controller 332.

The secure element 614 includes a processor 630 and a memory 632, which are enclosed in tamper resistant packaging. The memory 632 includes entitlements that the DSCT-PVR 110 has been granted to selectively access services, rights, and a private key of a public key-private key pair belonging to the DSCT-PVR 110. The memory 632 is accessible only to the processor 630 so as to protect the private key belonging to the DSCT-PVR 110.

The memory 632 also includes at least one trusted public key belonging to a trusted authority such as the operator of the STS 100. In one preferred embodiment, a trusted public key is used for establishing an entitlement agent, i.e., providing the entitlement agent's public key to the DSCT-PVR 110 and establishing parameters for which the entitlement agent must operate with regard to the DSCT-PVR 110.

The operator of the STS 100 establishes an entitlement agent with the DSCT-PVR 110 using EMMs that are assigned by the private key of the operator. The processor 630 uses the trusted public key to authenticate the EMMs from the operator of the STS 100, and if the EMMs include encrypted content, the processor 630 uses the private key of the DSCT-PVR 110 to decrypt the content. Typically, an entitlement agent is established by a series of EMMs, which provide the DSCT-PVR 110 with the public key of the entitlement agent, allocate a portion of the memory 632 to the entitlement agent, and establish operating parameters for the entitlement agent. The DSCT-PVR 110 considers the public key of the entitlement agent as genuine because it came in an EMM that was signed by the operator of the STS 100.

After the entitlement agent has been established with the DSCT-PVR 110, the entitlement agent sends entitlements, shared secrets, and multi-session keys (MSKs) to the DSCT-PVR 110 using EMMs. The processor 630 authenticates the EMMs as having come from the established entitlement agent using the public key of the entitlement agent. If the EMMs are authentic, the processor 630 stores the entitlements, shared secrets, and the MSKs in the memory 632.

In one preferred embodiment, the memory 632 includes a bitmap for storing entitlements. Each bit of the bit map is set to one of two predetermined values representing either entitled or not entitled and each bit is associated with a service. When a subscriber attempts to access a particular service, the processor 630 uses the SID 222 of the ECM 216 for the particular service to check the bit associated with that the particular service. If the bit is set to not entitled, the control word is not provided to the cryptographic device 68. However, if the bit is set to entitled, the secure element 614 provides the cryptographic device 618 with the control word used for decrypting the selected service instance. The cryptographic device 618 decrypts the selected service instance using the control word from the secure element 614 and the decrypted service instance is sent to the output port 622.

As previously described hereinabove, PATs 212 and PMTs 214 are used by the processor 612 to identify the PID values of the elementary streams of a user selected service and for identifying the PID values of ECMs 216 for the selected service. The ECMs 216 are provided to the processor 630, which uses the authentication token 230 to authenticate the ECM 216. In one embodiment, the processor 630 uses a portion of the payload 210 of the ECM 216 and a shared secret to generate a hash digest, and then compares the authentication token 230 with the generated hash digest. If the two are the same, the processor 630 determines the ECM is authentic, and then determines whether the DSCT-PVR 110 is entitled to access the user-selected service. If it is entitled, then the processor 630 uses the key identifier 224 to retrieve a particular MSK stored in memory 632. The processor 630 uses the MSK along with the DKM 226 to generate a control word for decrypting packets 204 carrying a portion of the selected service.

It should be noted that the control words are provided to the cryptographic device 618 only if the DSCT-PVR 110 is entitled to access the selected service. Thus, the DSCT-PVR 110 can have all the necessary information for generating a control word such as the appropriate MSK and the DKM 226, but it will still not be able to access the selected service unless it is entitled.

In one embodiment, encrypting the DMK 226 using the MSK, generates a control word. Typically, the DKM 226 is a counter value that is transmitted in the ECM without encryption. Encrypting the counter value produces an output, the control word, which is essentially a random number. In another embodiment, a control word is generated by decrypting the DKM 226 using the MSK as a key. Decrypting the DKM 226 converts the DKM from an encrypted value into a clear text value (the control word) and in this embodiment the clear text value was generally produced by a random number generator.

The reformatter 626 receives the decrypted service from the cryptographic device 618, and if the output port 622 is coupled to a VCR or TV, the reformatter 626 reformats the content from an MPEG format to an NTSC format. The reformatter 626 can also reformat the content to other formats appropriate for display on a computer or other user display device. Alternatively, in one embodiment, the content from the cryptographic device 618 can be sent directly to the output port 622 without being reformatted.

Embodiment 1

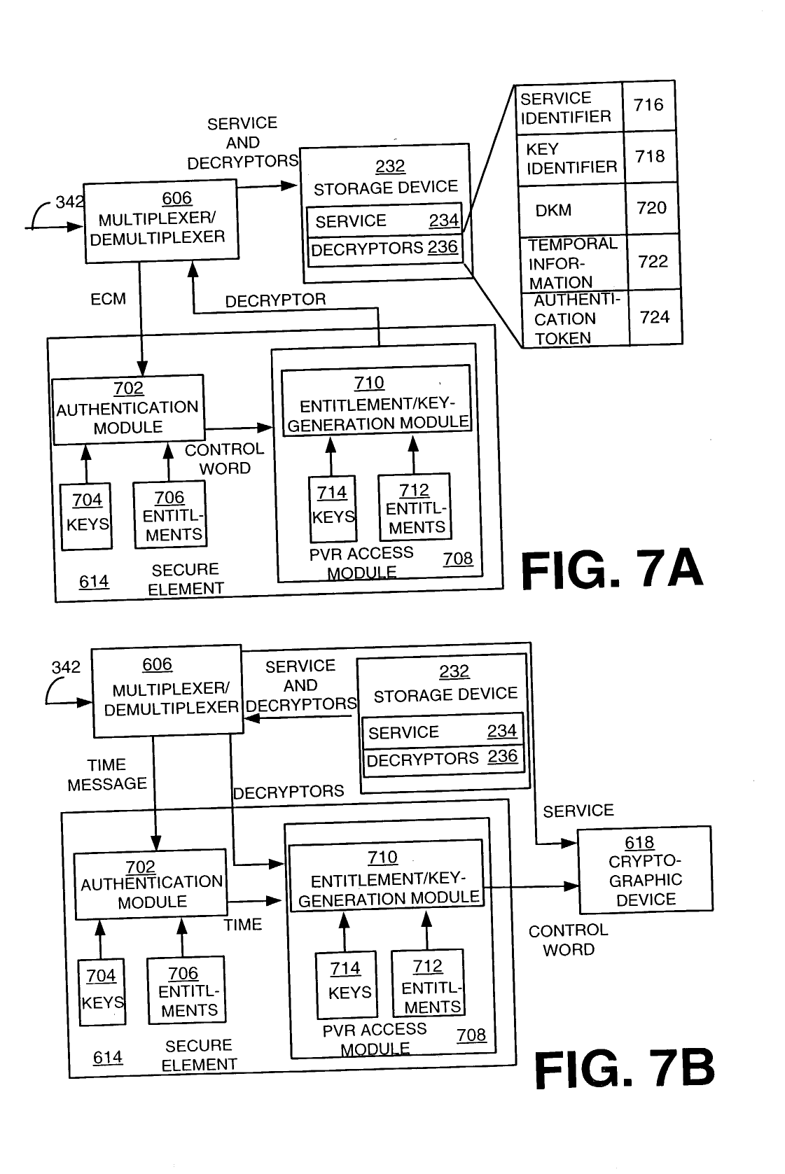

FIG. 7A illustrates the flow of packets 204 (see FIG. 2) carrying a portion of a selected service and packets carrying ECMs 216(see FIG. 2) as a selected service is being recorded in the storage device 232 (see FIG. 2). FIG. 7B illustrates the flow of packets 204 (see FIG. 2) as the recorded service 234 (see FIG. 2) is played. Functional components/modules of the secure element 614, which are embodied in the processor 630 and memory 632, are illustrated in FIGS. 7A and 7B. The functional components include an authentication module 702, and PVR access module 708, which includes a PVR entitlement-key generator module (EKG) 710. Also included the secure element 614 are keys 704, entitlements 706, PVR keys 714, and PVR entitlements 712. The keys 704, entitlements 706, and PVR entitlements 712 are assigned to the DSCT-PVR 110 by the system controller 332. The PVR keys 714 are typically generated at the DSCT-PVR 110 by a random number generator (not shown) or, alternatively, assigned to the DSCT-PVR 110 by the system controller 332.

In this embodiment, the multiplexer/demultiplexer 606 receives the transport stream 342 and extracts the packets carrying the elementary streams of the user selected service and the ECMs 216 associated with the selected service from the transport stream 342. The ECMs 216 are sent to the secure element 614, which processes them and generates decryptors 236 that are sent to the multiplexer/demultiplexer 606. The multiplexer/ demultiplexer 606 sends the elementary streams along with the decryptors 236 to the storage device 232.

The authentication module 702 authenticates an ECM 216 using the authentication token 230 of the ECM 216, as previously described hereinabove. In the case where the authentication token 230 is a digest of message content and a shared secret, the corresponding shared secret is stored in keys 704. The authentication module 702 includes an entitlement verifier that uses the service identifier 222 and entitlements 706 to verify that the DSCT-PVR 110 is entitled to access the selected service. Responsive to the DSCT-PVR 110 being entitled, the authentication module 702 uses the key identifier 224 to retrieve a specific key (MSK) from the keys 704.

The authentication module 702 includes a control word generator module that processes the DKM 226 along with the retrieved MSK from key 704 to generate a control word. As previously described, the DKM 226 is either encrypted or decrypted with the MSK to generate the control word which is then passed to the PVR access module 708.

The PVR access module 708 receives the control word and generates a decryptor 236. The decryptor 236 includes a service identifier 716 that identifies the service that is being recorded, a key identifier 718, decryptor key material (DKM) 720, temporal information 722, and an authentication token 724. The EKG module 710 receives the control word and first uses a PVR key 714 along with the control word as inputs to a hash function. The output of the hash function is the authentication token 724 for the decryptor 236. In another embodiment, the authentication token is the output of a hash function that includes at least a portion of the control word, and other information such as temporal information 722 as inputs.

Next, the EKG module 710 uses a key from PVR keys 714 to encrypt the control word thereby converting the control word into DKM 720. Generally, it is preferred to encrypt the control word using a symmetric encryption algorithm such as, but not limited to, DES or 3DES because, as those skilled in the art will recognize, symmetrical encryption algorithms are generally faster than asymmetrical encryption algorithms such as RSA. However, that not withstanding, the DKM 720 can be produced by encrypting the control word using either symmetrical or asymmetrical encryption algorithms.

The DKM 720 and authentication token 722 are then included in the decryptor 236. The decryptor 236 is formatted according to protocols consistent with the formatting of the packets carrying the selected service. Typically, the decryptor 236 is formatted according to MPEG protocols such that the decryptor 236 is an MPEG packet.

In this embodiment the temporal information 722 defines a time span over which the DSCT-PVR 110 is entitled to access the selected service that is being recorded. Typically, the temporal information 722 includes a beginning and ending entitlement time, or a reference time and an entitlement length. In that case, the entitled time span is defined as the reference time plus (or minus) the entitlement length.

In one embodiment, the entitled time span is one of the menu selections that the subscriber makes when the subscriber programs the DSCT-PVR 110 to record the service. The menu options present the subscriber with different rental periods: one day; three days; one week; etc. The rental period is included in the billing information, which is then sent to the controller 332.

In yet another embodiment, the temporal information defines an entitled time span of a predetermined length. Typically, the system controller 332 predetermines the entitled time span. The entitled time span is transmitted to the DSCT-PVR 110 using EMMs and stored in the memory 632 of the secure element 614. Alternatively, in another embodiment, the entitled time span is transmitted in packets that are received along with the ECMs and service.

Refer to FIG. 7B, when the subscriber attempts to access the recorded service 234, the multiplexer/demultiplexer 606 extracts time-messages 220 from the transport stream 342 and sends them to the authentication module 702. The packets 204 that make up the recorded service 234 and the decryptors 236 are sent to the multiplexer/demultiplexer 606, which also demultiplexes the decryptors 236 from the recorded service 234 and sends the decryptors 236 to the EKG module 710. The packets 204 carrying the recorded service 234 are sent to the cryptographic device 618.

The authentication module 702 authenticates that the time-message 220 is authentic by comparing an authentication token 230 included in the time-message 220 with a generated hash digest. The generated hash digest is the output of a hash function having at least a portion of the content of the time-message and a secret as inputs. If the time-message 220 is authentic, the authentication module provides the current time to the EKG module 710.

The EKG module 710 first authenticates the decryptor 236, which it receives from the multiplexer/demultiplexer 606. Using information included in the decryptor 236 and a secret from key 714 of the EKG module 710, the EKG module 710 generates a hash digest and compares the hash digest with the authentication token 724. The decryptor 236 is authentic if the hash digest and the authentication token 724 are the same. If the decryptor 236 is authentic, the EKG module 710 uses, among other things, the temporal information and the current time to determine whether the entitled time span for the recorded service 234 has expired. It should be noted that the temporal information 722 could define a future entitled time span. In that case, the recorded service 234 can be recorded in the storage device 232 and then released to the subscriber at a predetermined release date. If the current time is within the entitled time span defined by the temporal information 722, the EKG module 710 uses entitlements 712 and SID 716 to determine whether the DSCT-PVR 110 is still entitled to access the recorded service 234.

If the DSCT-PVR 110 is still entitled the EKG module 710 uses the DKM 720 and a specific key from keys 714, the specific key is identified by the key identifier 718 of the decryptor 236, and decrypts the DKM 720. Decrypting the DKM 720 converts the DKM 720 into a control word, which is then sent to the cryptographic device 618 for decrypting the packets of the recorded service 236.

It should be noted that if the DSCT-PVR 110 is not entitled to access the selected service when the subscriber attempts to record it, or is no longer entitled to access the recorded service 234, the DSCT-PVR 110 is adapted to send a message to the headend requesting that the DSCT-PVR 110 be so entitled. If the system controller 332 so decides, it will entitle the DSCT-PVR 110 using EMMs. Once the DSCT-PVR 110 is entitled, the subscriber can record the service or play back the recorded service 234.

Embodiment 2.

In this alternative embodiment, the DSCT-PVR 110 no longer determines whether it is entitled to record the selected service. Instead, the processor 612 instructs the multiplexer/demultiplexer 606 to pass the ECMs 216 associated with the selected service and the elementary streams of the selected service to the storage device 232. In this embodiment, the stored decryptors 236 are the ECMs that were generated at the headend 102.

The steps performed by components of the DSCT-PVR 110 to access the recorded service 234 are generally the same as illustrated in FIG. 7B and will not be described in detail again. A distinction between the first embodiment and the second embodiment is that the decryptors 236 are generated at the DSCT-PVR 110 in the first embodiment and the decryptors 236 are generated at the headend 102 in the second embodiment. Consequently, instead of using a key from keys PVR 714 to generate a control word, the MSK from keys 704 is provided to the EKG module 710 if the DSCT-PVR 110 is entitled to access the recorded service. To be entitled, the time-messages 220 must be authentic, the decryptors (ECMs) 236 must be authentic, the current time must be within the time span defined by the temporal information 722, and the value of the entitlement 712 must be set to entitled.

An advantage of the first embodiment is that the temporal information 228 of the ECM need not define an entitled time span over which the DSCT-PVR 110 is entitled to access the recorded service 234 because the time span can be included in the decryptor 236 when it is generated at the DSCT-PVR 110, thereby conserving bandwidth by sending less information downstream in the ECMs 216.

Another advantage of the first embodiment is that the user can determine the entitled time span before the user records the service. Again, this advantage comes from the fact that the decryptors 236 are generated at the DSCT-PVR 110.

However, an advantage of the second embodiment is that the DSCT-PVR 110 does not need to check its entitlements before recording the selected service. Thus, requiring less processing by the DSCT-PVR 110.

In addition, the second embodiment requires less processing at the DSCT-PVR 110 because the decryptors 236 (ECMs 216) are generated at the headend.

In addition, an advantage of the second embodiment is that a subscriber can record a service before being entitled to access the service. Thus, the subscriber can record a service to which he is not currently entitled to access, and then in the future, determine whether he wants to seek the entitlements to the recorded service. At which point in time, the subscriber can then request entitlement to the service from the headend 102 and be billed appropriately.

Embodiment 3.

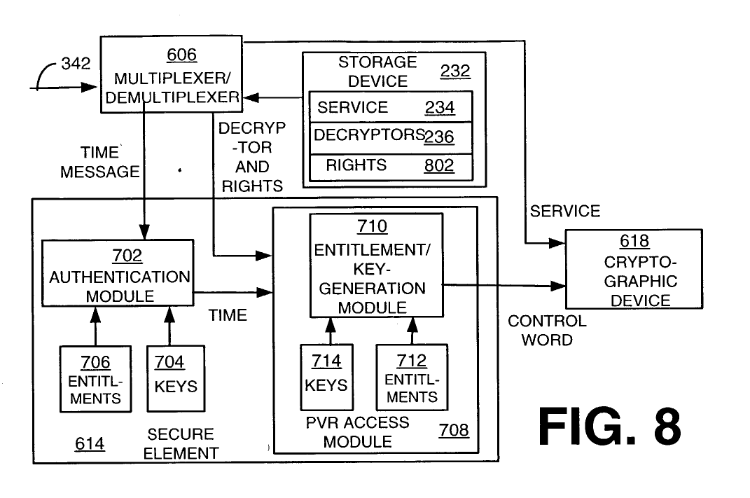

In this embodiment, the like number items of FIGS. 7A, 7B and 8 are the same and shall not be described again.

Refer to FIG. 8, in addition to storing the recorded service 234 and decryptors 236, the storage device 232 also stores Rights messages 802, which are transmitted from the headend 102. It should be noted that in this embodiment, the recording of the selected service could be implemented according to embodiment 1 or embodiment 2. Furthermore, it should be noted that the Rights messages 802 could be transmitted from the headend 102 as either in-band communication multiplexed into the transport stream 342 or out-of-band communication. If the Rights messages 802 are transmitted as in-band communication, the PMT 214 for the selected service includes the PID value that identifies the packets 204 that carry the Rights messages 802. The multiplexer/demultiplexer 606 extracts the Rights Packets from the transport stream 342 and sends them to the storage device 232. On the other hand, if the Rights messages are transmitted as out-of-band communication, the transceiver 608 sends the Rights messages to the storage device 232.

The Rights messages 802 include an authentication token that is a digitally signed output of a hash function, which was digitally signed by the private key of the system controller 332. Typically, the private key belongs to the operator of the STS 100, however, in one embodiment, the private key belongs to the entitlement agent that provides the DSCT-PVR 110 with entitlements to the selected service associated with the Rights message 802. Non-limiting examples of rights included Rights message 802 include detached viewing, buying/copying, and extended viewing.

When the subscriber attempts to access the recorded service 234, the time-message 220, the decryptors 236, and the Rights messages 802 are provided to the secure element 614. The control word for decrypting packets of the recorded service 234 is only given the cryptographic device 618 if all of the messages are authenticated, and only if the DSCT-PVR 110 is currently entitled and has the right to perform the functions requested by the subscriber. For example, when the subscriber attempts to access the recorded service 234, the subscriber is given various options such as Play or Copy. However, to operate in Copy mode the DSCT-PVR 110 checks the Rights messages 802 to determine whether the DSCT-PVR 110 has been authorized to copy the recorded service 234. The content of the recorded service 234 is decrypted and provided to an external storage device such as a DVD burner (not shown) via output port 622 only if the Rights messages 802 includes Copy permission and is authentic.

In addition, rights included in the Rights message 802 can include detached viewing, and in that case, the secure element 614 is adapted to check the Rights message 802 and generate the control word without receiving the time-message 220. However, if the Rights message 802 does not include detached viewing rights, then the control word is not provided to the cryptographic device 618 if the secure element 614 does not receive the time-message 220.

Furthermore, rights included in the Rights message 802 can include temporal information that defines an entitled time span. Typically, the temporal information of Rights message 802 defines an extended viewing right that extends the original entitled time span for the recorded service 234. However, the temporal time span of Rights message 802 can define the original entitled time span. For example, instead of including the temporal information that defines an entitled time span in an ECM 216, the temporal information is transmitted as in-band information to the DSCT-PVR 110 as Rights messages 802. In this example, the decryptor 236 would not need to include the temporal information 722 because the entitlement time span is then defined by the temporal information included in the Rights message 802.

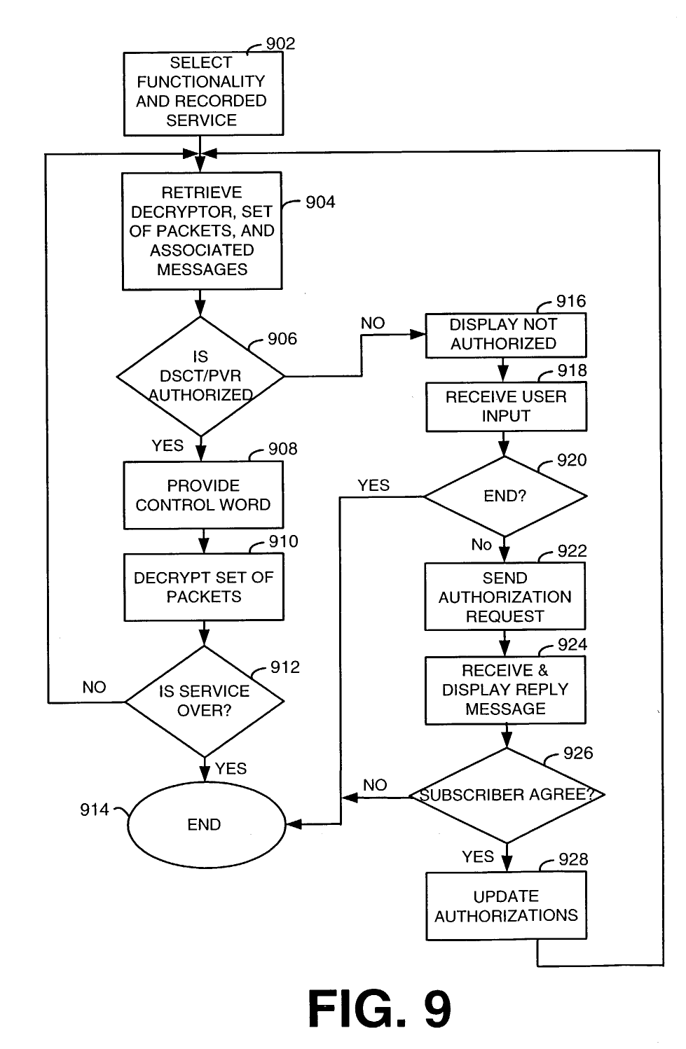

Refer to FIG. 9, which illustrates exemplary steps to access the recorded service 234, the subscriber attempts to access the recorded service 234 in step 902. In the preferred embodiment, the subscriber is given a menu of recorded services from which he chooses which of the recorded service he wants to access. The menu is displayed on a user display device, such as the television 112 and the subscriber uses a subscriber input device (not shown) for inputting his selection. In addition to the user choosing which recorded service 234 to access, the subscriber may also provide other information such as whether he desires to buy (or copy) or rent the selected service.

In step 904, a portion of the selected recorded service 234 is retrieved from the storage device 232 along with at least one decryptor 236 associated with that portion of the selected service. Other service information such as recorded Rights messages 802 and other recorded messages are also retrieved from storage device 232.

In step 906, the DSCT-PVR 110 determines whether it is authorized to access the selected service in the manner chosen by the subscriber. The DSCT-PVR 110 needs different authorizations for different functionality. For example, the authorizations (entitlements and rights) to copy the selected service are different from the authorizations for playing the selected service.

If the DSCT-PVR 110 is authorized, then in step 908, the secure element 614 provides the control word, which was generated, from the retrieved decryptor 236, to the cryptographic device 618. In step 910, the cryptographic device 618 uses the control word to decrypt the retrieved packets and sends the decrypted packets to the reformatter 626. The reformatter 626 reformats, or not, the content of the decrypted packets according to the type of user device coupled to the output port 622.

In step 912, the DSCT-PVR 110 determine whether the service is over, i.e., whether the retrieved set of packets were the last set of packets of the recorded service 234. If the service is not over, the DSCT-PVR 110 proceeds back to step 904. On the other hand, when the service is over, the DSCT-PVR 110 ends the process at step 914.

Refer back to step 906, when the DSCT-PVR 110 is not authorized, then in step 916, the DSCT-PVR 110 informs the subscriber that the DSCT-PVR 110 is not authorized. The DSCT-PVR 110 may not be authorized if the subscriber selected to copy the recorded service 236, and the subscriber had never purchased the right to copy, or if the entitlement time of the recorded service has expired. The subscriber is told why the DSCT-PVR 110 is not authorized and is given options for seeking authorization or ending the attempt to access the selected-recorded service 234. Typically, the subscriber is given the cost of seeking the necessary authorization. For example, extending the rental period for the recorded service 234 for another week maybe $4.99, and for another month the cost may be $10.99.

In step 918, the DSCT-PVR 110 receives the subscriber's input, and in step 920, the DSCT-PVR determines whether the subscriber wishes to end his attempt to access the recorded service 234.

If the subscriber decided to continue, the DSCT-PVR 110 sends a secure message 400 to the headend 102 requesting the necessary rights and/or entitlements to access the recorded service 234. At the headend 102, the system controller 232 receives the secure message and processes the request. Processing the request includes authenticating the message, and determining whether the system operator is authorized to grant the requested authorizations. For example, the subscriber may have requested that the rental period be extended for another thirty days, but the operator may only be able to extend the rental period for another week. In either case, the system controller 332 creates and sends a reply message, which is a secure message 400 that includes authorizations for the DSCT-PVR 110. Preferably, the authorizations of the reply message are the requested authorizations; however, the authorizations of the reply message could also be different from the requested authorizations.

In step 924, the DSCT-PVR 110 receives the reply message. The secure element 614 processes the reply message using its private key to decrypt the content 404 and the public key of the system controller 232 as part of authenticating the reply message. The reply message is displayed to the subscriber if the reply message was authentic. Otherwise, a non-authorized message is displayed.

In step 926, the subscriber inputs his acceptance of the terms of the requested authorizations. If he does not agree to the terms, the DSCT-PVR 110 ceases its attempts to access the recorded service 234 by proceeding to step 914. On the hand, if the subscriber accepts the terms, then in step 928, the rights and entitlements of the DSCT-PVR 110 are updated, and the reply message is stored in the storage device 232.

In an alternative embodiment, before the headend sends the reply message to the DSCT-PVR 110, the headend 110 sends a message that includes the terms for authorizing the DSCT-PVR 110. The subscriber agrees to the terms sending another message to the headend 110 acknowledging his consent. Only after the subscriber has agreed to the terms does the headend 110 send the reply message with the rights and entitlements to the DSCT-PVR 110.

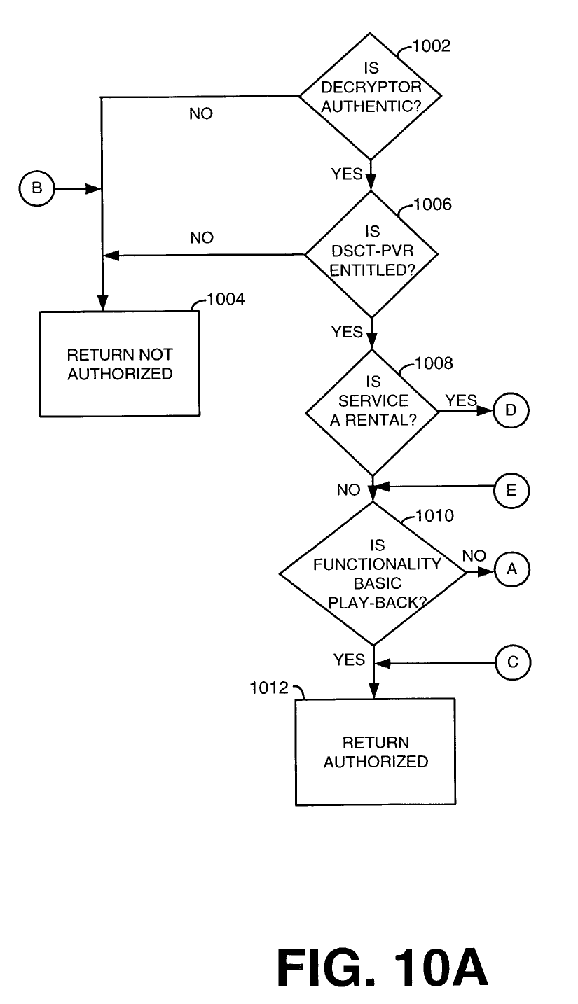

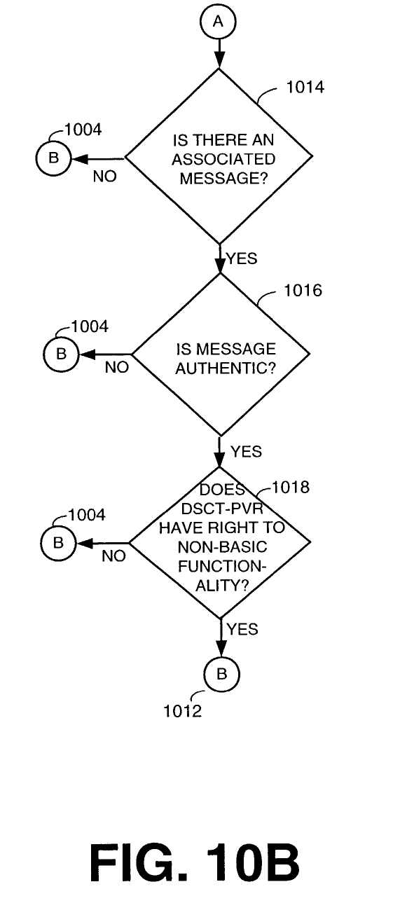

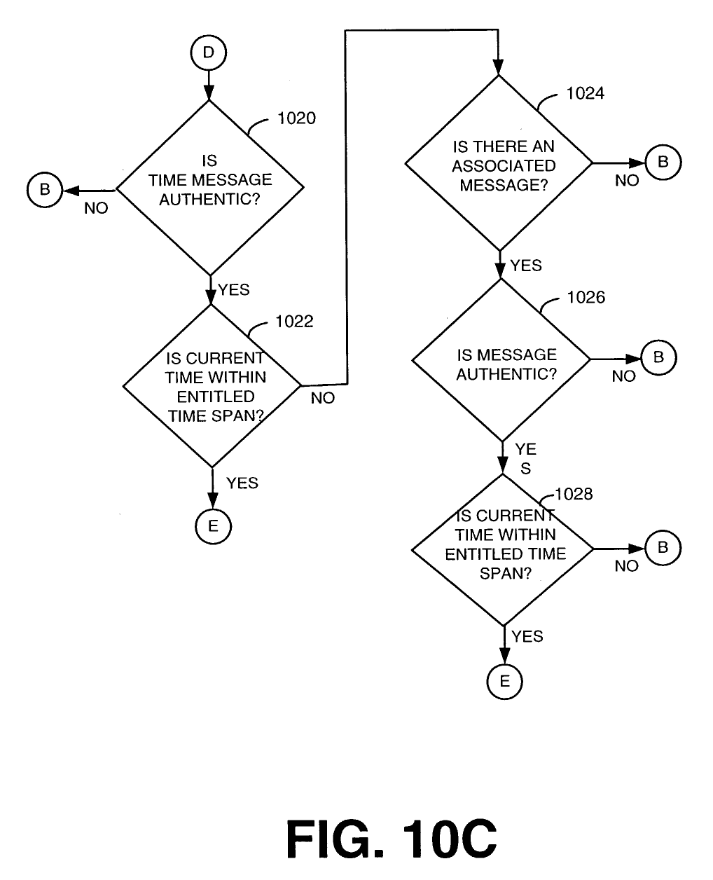

Refer to FIGS. 10A through 10C, steps 1000 are exemplary steps taken by the secure element 614 for implementing step 906. In step 1002, the secure element determines whether the decryptor is authentic, and if not, it proceeds to step 1004 where it returns “not authorized.” As previously described hereinabove, the decryptor includes an authentication token, which is the output of a hash function having decryptor content and other information as input. To authenticate the decryptor, the secure element 614 uses at least a portion of the decryptor and other information as inputs to a hash function, which then generates a hash digest, and compares the hash digest with the authentication token. If they are the same, the decryptor is authentic and the secure element proceeds to step 106.

The secure element 614 checks the entitlement setting that is associated with the recorded service 234 and determines therefrom whether the DSCT-PVR 110 is entitled to access the recorded service 234. If not, it proceeds to step 1004. On the other hand, if the DSCT-PVR 110 is entitled, then the secure element 614 proceeds to step 1008 and determines whether the recorded service 234 is a rental. If the recorded service is not a rental, the secure element 614 proceeds to step 1010.

In step 1010, the secure element 614 determines whether the user requested functionality of the DSCT-PVR 110 is basic playback functionality, and if so, the secure element 614 proceeds to step 1012 and returns “authorized.” On the other hand, when the subscriber wants his DSCT-PVR 110 to function beyond its basic functionality, such as, but not limited to, playing the recorded service 234 when detached from the STS 100, or copying the recorded service, then the DSCT-PVR 110 must have the appropriate right to extend its functionality.

Refer to FIG. 10B, responsive to determining that the requested functionality of the DSCT-PVR 110 is not basic playback, the secure element 614 proceeds to step 1014 and determines whether there is an associated message that extends the rights of the DSCT-PVR 110. Associated messages can be stored with the recorded service 234 in the storage device 232 or in the memory 632. If there is no message associated with the recorded service 234, then the secure element proceeds to step 1004 and returns “not authorized.” On the other hand, if there is an associated message and the message is a Rights message giving the DSCT-PVR 110 the necessary right to extend its functionality, then in step 1016 the secure element 614 determines whether the Rights message is authentic.

Typically, Rights messages are secure messages 400, which use encryption to keep the content 404 private and an authentication token 406 for providing a way of verifying the authenticity of the message. The authentication token is generally a digitally signed hash digest, and the secure element uses the public key of the signer to verify the signature of the purported sender and its own private key to decrypt the content 404. Alternatively, a symmetrical key that is known to both the sender and the DSCT-PVR 110 can encrypt and decrypt the content 404.

In another embodiment, a Rights message could be akin to an ECM 216, except that it would include an authorization token that was signed by the system controller 332. In this embodiment, the content of the Rights message would not be encrypted using a public key because the Rights message would be broadcast through the STS 100 to multiple DSCT-PVRs 110. In that case, if the content of the Rights message is encrypted, it is encrypted using a key that is known to both the system controller 332 and the DSCT-PVRs 110. For example, the system controller 332 could encrypt the content using the MSK.

Responsive to the Rights message being authentic, in step 1018 the secure element determines whether the Rights message grants the requested functionality. If the Rights message grants the DSCT-PVR 110 the right to perform the user-selected functionality, the secure element proceeds to step 1012 (see FIG. 10A) and returns “authorized,” otherwise it proceeds to step 1004 and returns “not authorized.”

Referring back to step 1008, responsive to the recorded service 234, being a rental, the secure element 614 proceeds to step 1020 (see FIG. 10C) and determines whether a time-message 220 that was transmitted from the headend 102 is authentic. If the time-message is not authentic, the secure element 614 proceeds to step 1004 (see FIG. 10A). On the other hand, the secure element 614 proceeds to step 1022 if the time-message is authentic and determines whether the time of the time-message is within the entitled time span for the recorded service 234. Typically, the entitled time span is defined by the temporal information of the decryptor 236, but in an alternative embodiment, the entitled time span can also be stored in the memory 632 of the secure element 614. If the current time is within the entitled time span, the secure element proceeds to step 1010 (see FIG. 10A).

On the other hand, responsive to the time not being within the entitled time span, the secure element 614 proceeds to step 1024 and determines whether there is an associated message, such as a Rights message, that is associated with the recorded service 234. If there is an associated message, the secure element 614 proceeds to step 1026 and determines whether it is authentic. Responsive to the message being authentic, in step 1028 the secure element 614 determines whether the current time is within an entitled time span defined by the Rights message. The entitled time span can be then time span for which the DSCT-PVR 110 was originally entitled or it may be an extension of the original entitled time span. If the current time is within the entitled time span, the secure element 614 proceeds to step 1010.

In steps 1024, 1026 and 1028, responsive to a negative result; there is no associated message; the associated message is not authentic; or the current time is not within the extended time span, respectively, the secure element 614 proceeds to step 1004.

Typically, Rights messages 802 of this third embodiment are used to extend subscriber access and DSCT-PVR 110 functionality beyond what was granted when the recorded service 234 was recorded. The DSCT-PVR 110 uses the Rights messages in conjunction with decryptors and entitlements and when appropriate in conjunction with time-messages to determine whether the DSCT-PVR 110 should access the recorded service 234 as requested by the subscriber. For example, if the subscriber does not own the recorded service 234, the DSCT-PVR 110 may allow him to access the recorded service 234 to play on a TV but not to copy it because he does not have that right.

Embodiment 4.

In this embodiment, the DSCT-PVR 110 generates a challenge, which is transmitted to the system controller 332 when the subscriber attempts to access the recorded service 234. The secure element 614 generates a random number, which is the challenge, retains the challenge in memory, and sends a copy of the challenge to the system controller 332 in a secure message. The system controller 332 authenticates the challenge message and generates a reply message, which is a secure message. The content 404 of the reply challenge message includes the challenge and the current time. Typically, the content 404 is encrypted using the public key of the DSCT-PVR 110 by the system controller 332. Alternatively, a key such as an MSK that is known to both the system controller 332 and the secure element 614 is used to encrypt the content. The system controller 332 sends the reply challenge message, which includes an authentication token that was digitally signed by the system controller 332, to the DSCT-PVR 110.

The secure element 614 of the DSCT-PVR 110 decrypts the content and authenticates the reply challenge message, and compares the challenge of the reply challenge message with the random number retained in memory 632. The reply challenge message is authenticated using the challenge and the authentication token. If the reply challenge message is not authentic, the secure element 614 will not provide the control word to the cryptographic device 618 for decrypting the recorded service 234. In addition, the secure element 614 uses the current time of the reply challenge message as a reference time and compares the current time of time-messages 220 against the reference time. The secure element 614 will not provide control words to the cryptographic device 618 when the current time of a time-message 220 is earlier than the reference time. The reference time prevents a subscriber from replaying earlier time-messages to access a recorded service 234 that has an expired entitled time span. The secure element 614 cannot be tricked by time-messages that are replayed into believing that the current time is within the expired time span because the purported current time of the replayed time-messages will be earlier than the reference time.

Embodiment 5.

In this embodiment, the DSCT-PVR 110 generates a rights-challenge message, which is transmitted to the system controller 332 when the subscriber attempts to access the recorded service 234. The secure element 614 generates a random number, which is the challenge, and retains the random number in memory 632. The secure element 614 generates a right-challenge message, which is a secure message having an encrypted content 404 and authentication token 406. The encrypted content of the rights-challenge message includes the challenge and rights of the DSCT-PVR 110, and the content is encrypted using either the public key of the system controller 332 or a key common to both the system controller 332 and the secure element 614 such as an MSK. The rights-challenge message is transmitted to the system controller 332, which decrypts the encrypted content 404 and uses the decrypted content, the public key of the DSCT-PVR 110, and the authentication token 406 to authenticate that the DSCT-PVR 110 was the actual sender and that the received content is correct. The system controller 332 determines new rights for the DSCT-PVR 110. The new rights can be the same as the rights already granted to the DSCT-PVR 110, or a further extension of granted rights including granting rights previously not granted, or a contraction of granted rights including denying rights previously granted.

The system controller 332 includes the new rights along with the challenge in a reply rights-challenge message, which is a secure message having an authentication token. The system controller 332 generates the authentication token by inputting at least a portion of the content of the reply rights-challenge message, and possibly a shared secret, into a hash function and digitally signing the output using the private key belonging to the system controller 332. The content of the reply rights-challenge message is then encrypted using either the public key of the DSCT-PVR 110 or a shared key such as an MSK. The reply rights-challenge message is then transmitted out-of-band to the DSCT-PVR 110.

The secure element 614 of the DSCT-PVR 110 receives the reply rights-challenge message and decrypts the content 404. Next, the reply rights-challenge message is authenticated using the public key of the system controller 332, the authentication token, at least a portion of the decrypted content 404, and a shared secret if a shared secret was used by the system controller 332 in generating the authentication token 406. Responsive to the reply rights-challenge message being authentic, the secure element 614 compares the challenge included in the reply rights-challenge message with the random number retained in memory 632 and updates the rights 802 with the new rights included in the reply rights-challenge message if random number and the challenge are the same. The secure element 614 provides a control word to the cryptographic device 618 only if: the reply rights-challenge message was authentic; the returned challenge was the same as the random number retained in memory 632; and if the new rights authorize the DSCT-PVR 110 to access the recorded service 236.

In this embodiment a subscriber can initially record a service without having the right to access the service. The right to access the recorded service can be granted in the reply rights-challenge message when the subscriber attempts to access the recorded service 234.

Although exemplary preferred embodiments of the present invention have been shown and described, it will be apparent to those of ordinary skill in the art that a number of changes, modifications, or alterations to the invention as described may be made, none of which depart from the spirit of the present invention. Changes, modifications, and alterations should therefore be seen as within the scope of the present invention. For example, in another alternative embodiment, the DSCT-PVR includes a clock for providing the current time to the secure element 614. Preferably, the clock is included in the secure element and cannot be reset by the subscriber. The secure element 614 would then use the time from the clock for determining whether the current time is within an entitled time span for a given service. It should also be emphasized that the above-described embodiments of the present invention, particularly, any “preferred embodiments” are merely possible non-limiting examples of implementations, merely setting forth a clear understanding of the principles of the inventions.

What is claimed is:

1. A method of providing through a settop a digital service to a subscriber in a digital subscriber system having a headend, the method comprising the steps of:
retrieving a given decryptor and a set of packets from a storage device, the set of packets carrying a portion of a digital service, wherein the storage device has multiple sets of packets and multiple decryptors stored therein, each decryptor associated with a particular set of packets, and the multiple sets of packets make up the digital service; and
determining whether the settop is entitled to access the set of packets by at least processing at least a portion of the given decryptor;
responsive to determining the settop is entitled to access the set of packets, further including the steps of:
processing at least a portion of the given decryptor with a first key to generate a decryption-key therefrom; and
decrypting content included in the set of packets with the decryption-key.

2. The method of claim 1, prior to the step of retrieving, further including the steps of:
receiving packets carrying the digital service and a plurality of entitlement control messages; and
storing the packets carrying the digital service and multiple decryptors.

3. The method of claim 2, wherein the digital service and the entitlement control messages are received through a communication link extending between a headend of the digital subscriber system and the settop disposed at a remote location.

4. The method of claim 2, wherein each entitlement control message includes a shared-secret identifier and decryption-key-material, and prior to the step of storing, further including the steps of:
retrieving a shared-secret using the shared-secret identifier, wherein the shared-secret is a second key shared by both the headend and the settop;
determining whether the settop is entitled to access the digital service by processing at least a portion of a given entitlement control message of the plurality of received entitlement control messages; and
responsive to determining the settop is entitled to access the digital service, further including the steps of:
generating the decryption-key by processing the decryption-key-material of the given entitlement control message with the retrieved shared-secret; and
encrypting the decryption-key with the first key to generate an encrypted decryption-key, wherein the encrypted decryption-key is included in the decryptor.

5. The method of claim 4, wherein the step of processing at least a portion of the decryptor with the first key includes the step of:
decrypting the encrypted decryption-key with the first key thereby generating the decryption-key.

6. The method of claim 4, wherein the act of processing the decryption-key-material with the shared-secret includes the act of encrypting the decryption-key-material.

7. The method of claim 4, wherein the act of processing the decryption-key-material with the shared-secret includes the act of decrypting the decryption-key-material.

8. The method of claim 4, wherein the step of determining whether the settop is entitled to access the digital service further includes the step of:
authenticating the given entitlement control message using at least a portion of the shared-secret and at least a portion of the entitlement control message.

9. The method of claim 8, wherein the step of authentication further includes the steps of:
generating a first authentication token by processing at least a portion of the content of the given entitlement control message with the shared-secret, wherein the content of the given entitlement control message includes a second authentication token; and
determining whether the first authentication token and the second authentication token are the same, wherein responsive to the first and second authentication token being the same, the given entitlement control message is authentic.

10. The method of claim 4, and wherein the given entitlement control message further includes a service-identifier associated with the digital service, and further including the steps of:
receiving at the settop a management message having an entitlement setting of the settop for the digital service included therein, wherein the entitlement setting indicates whether the settop is entitled to access or is not entitled to access the digital service; and
storing the entitlement setting of the settop for the digital service in a memory; and
wherein the step of determining whether the settop is entitled to access the digital service further includes the step of:
using the service-identifier of the given entitlement control message to check the entitlement setting.

11. The method of claim 1, wherein the given decryptor further includes a first key-identifier for identifying the first key, an authentication token, a service-identifier, and temporal information associated with the digital service.

12. The method of claim 11, wherein the given decryptor is an entitlement control message, which was received from the headend and stored in the storage device.

13. The method of claim 11, wherein the given decryptor was generated at the settop and stored in the storage device.

14. The method of claim 11, wherein the temporal information includes a broadcast time specifier associated with when the digital service was broadcast from the headend.

15. The method of claim 11, wherein the temporal information defines a time-span over which the digital service can be accessed.

16. The method of claim 1, wherein the step of determining whether the settop is entitled further includes the steps of:
receiving from the headend a time-message having a time specifier, a shared-secret identifier for identifying a shared-secret and a authentication token included therein; and
authenticating the time-message using at least the shared-secret and at least a portion of the time-message.

17. The method of claim 16, wherein the step of authenticating the time-message further includes the steps of:
generating a second authentication token by processing at least a portion of the content of the time-message with the shared-secret; and
determining whether the first authentication token and the second authentication token are the same, wherein responsive to the first and second authentication token being the same, the time-message is authentic.

18. The method of claim 17, further including the step of:
determining whether a time indicator included in the time-message is within an entitled time-span defined by temporal information included in the decryptor; and
determining whether an entitlement setting associated with the decryptor is set to entitled, wherein the settop is entitled to access the digital service responsive to both the time-message being authentic, the time being within the defined time-span and the entitlement setting being set to entitled.

19. The method of claim 1, wherein the step of determining whether the settop is entitled further includes the step of:
authenticating the given decryptor using at least the first key and at least a portion of the given decryptor.

20. The method of claim 19, wherein the step of authenticating the given decryptor further includes the steps of:
generating a second authentication token by processing at least a portion of the content of the given decryptor with the first key; and
determining whether the first authentication token and the second authentication token are the same, wherein responsive to the first and second authentication token being the same, the given decryptor is authentic.

21. The method of claim 20, further including the step of:
determining whether an entitlement setting associated with the given decryptor is set to entitled, wherein the settop is entitled to access the digital service responsive to both the given decryptor being authentic and the entitlement setting being set to entitled.

22. The method of claim 19, wherein the given decryptor is an entitlement control message that was received from the headend and stored in the storage device.

23. The method of claim 22, wherein the first key is a shared secret key that is shared by both the headend and the settop.

24. The method of claim 19, wherein the given decryptor is generated at the settop.

25. The method of claim 1, further including the steps of:
retrieving a PVR-Rights ECM from the storage device, wherein the PVR-Rights ECM includes a service-right identifier; and
authenticating the PVR-Rights ECM, wherein responsive to the PVR-Rights ECM not being authentic, at least one selected function of the settop cannot be performed.

26. The method of claim 25, wherein responsive to the PVR-Rights ECM being authentic, further including the steps of:
determining a service-right setting identified by the service-right identifier is set to entitled or not entitled, wherein the service-right setting is associated with a given function of the settop, and responsive to the service-right setting being set to not entitled, the settop cannot perform the given function.

27. The method of claim 26, wherein the given function is a digital service duplication function, and responsive to the setting being set to entitled, the settop duplicates the digital service.

28. The method of claim 27, wherein the duplicate digital service is stored in an external device, and the external device is adapted to provide the digital service independent of the settop.

29. The method of claim 26, further including the steps of:
responsive to determining the service-right setting identified by the service-right identifier is set to not entitled;
transmitting a first message to the headend;
receiving a second message from the headend;
authenticating the second message, wherein responsive to the second message being authentic, the settop can perform the given function.

30. The method of claim 25, further including the steps of:
receiving a PVR-rights management message having at least one PVR service right setting included therein;
determining whether the PVR-rights management message is authentic; and
responsive to the PVR-rights management message being authentic, storing the PVR service rights in a memory.

31. The method of claim 30, wherein the PVR-Rights management message includes a public-key identifier, a first authentication token, and encrypted content, and the step of determining whether the PVR-Rights management message is authentic further includes the steps of:
decrypting the encrypted content of the PVR-Rights management message with a private key of a private key-public key pair belonging to the settop;
decoding the first authentication token with a public key associated with the public-key identifier;
generating a second authentication token at least a portion of the decrypted content of the PVR-Rights management message; and
comparing the decoded first authentication token with the second authentication token, wherein the PVR-Rights management message is authentic if the decoded first authentication token and the second authentication token are the same.

32. The method of claim 1, wherein the step of determining whether the settop is entitled further includes the steps of:
transmitting a message to the headend, the message including a challenge;
receiving a message from the headend, the message including the challenge, a time indicator, and an authentication token; and
authenticating the message, wherein the settop is entitled to access the digital service only if the message is authentic.

33. The method of claim 32, wherein the step of authenticating the message further includes the steps of:
generating a second authentication token by processing at least a portion of the content of the message with a shared-secret; and
determining whether the first authentication token and the second authentication token are the same, wherein responsive to the first and second authentication token being the same, the message is authentic.

34. The method of claim 33, wherein the step of determining whether the settop is entitled further includes the steps of:
receiving from the headend a time-message having a second time indicator, a shared-secret identifier for identifying a shared-secret and a authentication token included therein; and
authenticating the time-message using at least the shared-secret and at least a portion of the time-message; and
comparing the first time indicator to the second time indicator, wherein the settop is only entitled if both the first message and the time-message are authentic and if the second time indicator is not earlier than the first time indicator.

35. The method of claim 1, wherein the storage device has a plurality of decryptors stored therein, each decryptor is associated with a set of packets of the multiple packets carrying the digital service and includes decryption-key-material for generating a decryption-key to decrypt content included in the associated set of packets, the decryption-key-material of a first decryptor of the plurality of decryptors is different from the decryption-key-material of a second decryptor of the plurality of decryptors, and the decryption-key generated from the first decryptor is different from the decryption-key of the second decryptor.

36. A Personal Service Recorder (PSR) for providing a user with a recorded digital service, the PSR comprising:
a storage device adapted to store a digital service carried in a plurality of packets and a plurality of decryptors, each decryptor associated with a set of packets of the plurality of packets, wherein each set of packets make up a portion of the digital service;
an entitlement-verifier module in communication with the storage device adapted to receive from the storage device a given decryptor of the plurality of decryptors and determine whether the PSR is entitled to access a given set of packets by at least processing at least a portion of the given decryptor; and
a key-generation module in communication with the entitlement-verifier, the key-generation adapted to generate a decryption-key using a first key and at least a portion of the given decryptor, wherein the key-generation module only generates the decryption-key responsive to entitlement-verifier determining the PSR is entitled to access the given set of packets.

37. The PSR of claim 36, wherein the decryption-key generated by the key-generator using at least a portion of the given decryptor is different from a second decryption-key generated by the key-generator using at least a portion of a second given decryptor.

38. The PSR of claim 36, further including:
a decryption module in communication with the key-generation module and the storage device, the decryption module adapted to receive the decryption-key and the given set of packets, each packet of the set of packets carrying encrypted content, and decrypt the encrypted content included in the given set of packets using the decryption key.

39. The PSR of claim 36, further including:
a memory in communication with the key-generation module and the entitlement-verifier module, the memory having the first key included therein and entitlement setting included therein, wherein the entitlement-verifier module uses at least a portion of the entitlement settings to determine whether the PSR is entitled to access the given set of packets.

40. The PSR of claim 39, further including:
an authenticator module in communication with the storage device and the entitlement-verifier, the authenticator module adapted to receive the given decryptor and determine whether the decryptor is authenticate using at least a portion of the decryptor and the first key.

41. The PSR of claim 40, wherein responsive to the authenticator module determining that the decryptor is not authentic, the entitlement-verifier determines that the PSR is not entitled to access the given set of packets.

42. The PSR of claim 40, wherein the decryptor includes a first authentication token, and the authenticator module is adapted to generate a second authentication token from at least a portion of the decryptor and at least a portion of the first key and compare the first and second authentication tokens, wherein responsive to the first and second authentication tokens being the same, the authenticator module determines the decryptor is authentic.

43. The PSR of claim 40, wherein the memory includes a private key of a private key-public key pair belonging to the PSR, and the entitlement-verifier module, the key-generator module, the authenticator module, and the memory are included in a secure element, and the private key is not accessible to modules outside of the secure element.

44. The PSR of claim 40, wherein the PSR is in communication with a headend of a subscriber television system that provides digital services to the PSR, and the PSR receives a time-message from the headend, the time-message including a time indicator, a shared secret identifier, and a first authentication token, wherein the memory includes a shared secret associated with the shared secret identifier, the authenticator retrieves the shared secret from the memory using the shared secret identifier and determines whether the time-message is authentic using at least a portion of the time-message and at least a portion of the shared secret, and responsive to the time-message not being authentic, the entitlement-verifier determines that the PSR is not entitled to access the given set of packets.

45. The PSR of claim 44, wherein responsive to the authenticator determining the time-message is authentic, the entitlement-verifier uses at least the time indicator to determine whether the PSR is entitled to access the given set of packets.

46. The PSR of claim 45, wherein the decryptor includes temporal information that defines a time span over which the PSR is entitled to access the set of packets, and the PSR is entitled to access the set of packets responsive to the time indicator being within the defined time span.

47. The PSR of claim 45, wherein the memory includes temporal information that defines a time span over which the PSR is entitled to access the set of packets stored therein, and the PSR is entitled to access the set of packets responsive to the time indicator being within the defined time span.

48. The PSR of claim 40, further including:
a decryptor-generator module in communication with the memory adapted to receive an particular Entitlement Control Message having a service identifier, a shared-secret identifier, key-decryption-material, and an authentication token include therein and generate therefrom a particular decryptor using at least the Entitlement Control Message and the first key.

49. The PSR of claim 48, wherein the authenticator is adapted to receive the Entitlement Control Message and determine whether the Entitlement Control Message is authentic, and the decryptor-generator module is adapted to generate a decryptor only if the authenticator module has determined the Entitlement Control Message is authentic.

50. The PSR of claim 49, wherein the memory includes a shared secret that is shared by PSR and the headend, wherein the authenticator generates a second authentication token using at least a portion of the Entitlement Control Message and the shared secret and compares the second authentication token with the authentication token of the Entitlement Control Message and determines the Entitlement Control Message is authentic responsive to the two authentication tokens being the same.

51. The PSR of claim 49, wherein the memory includes a shared secret that is shared by PSR and the headend, wherein the decryptor-generator module is adapted to process the key-decryption-material of the Entitlement Control Message with the shared secret to generate a particular decryption-key, wherein the decryptor-generator module encrypts the particular decryption-key with the first key and includes the encrypted decryption-key in a particular decryptor.

52. The PSR of claim 51, wherein decryptor-generator module is adapted to include temporal information and an authentication token in the particular decryptor.

53. The PSR of claim 51, wherein responsive to the authenticator module determining that the Entitlement Control Message is authentic, the entitlement-verifier module determines whether the PSR is entitled to access packets of the digital service, and responsive to the entitlement-verifier determining the PSR is entitled to access packets of the digital service, the decryptor-generator module generates the decryption-key by encrypting the decryption-key-material with the shared secret.

54. The PSR of claim 36, further including:
a challenge module in communication with the key-generation module, the challenge module adapted to generate a challenge and include the challenge in a message.

55. The PSR of claim 54, wherein the challenge module is further adapted to receive a reply challenge message and authenticate the reply challenge message using the generated challenge.

56. In a subscriber television system having a headend in communication with a settop, a method of providing a recorded digital service to a subscriber of the digital subscriber system, the method implemented in the settop and comprising the steps of:
(a) receiving a message from the headend, the message specifying a time;
(b) retrieving from a storage device a given decryptor, the storage device having a plurality of decryptors and a digital service that is carried in a plurality of packets stored therein the storage device, wherein each decryptor is associated with a set of packets of the plurality of packets, and each decryptor includes decryption-key-material for generating a decryption-key to decrypt the set of packets associated with the decryptor;
(c) processing the decryption-key-material included in the given decryptor with a first key to generate a decryption-key therefrom;
(d) determining whether the settop is entitled to access the recorded digital service by using at least a portion of the given decryptor and at least the specified time; and:
responsive to determining the settop is entitled to access the digital service, further including the steps of:
(e) decrypting the set of packets associated with the decryptor using the decryption-key;
(f) determining whether the entire recorded digital service has been accessed; and
(g) responsive to determining that the entire digital service has not been accessed, repeating steps (a) through (f).

57. The method of claim 56, wherein the step of determining whether the settop is entitled to access the recorded service further includes the steps of:
(h) authenticating the message from the headend;
(i) authenticating the decryptor, wherein the settop is only entitled if the both the message and decryptor are authentic; and
(j) responsive to the decryptor being authentic, further including the steps of:
(k) determining an entitlement specifier from the decryptor, the entitlement specifier specifying an entitlement setting for the recorded digital service; and
(l) checking the entitlement setting for the recorded digital service using the entitlement specifier, wherein the settop is only entitled if the entitlement setting is set to a predetermined value.

58. The method of claim 57, wherein the step of authenticating the decryptor further includes the steps of:
(m) generating a first hash digest using at least secret information related to the decryptor as an input into a first hash function;
(n) comparing the first hash digest with a first authentication token included in the decryptor, wherein the decryptor is authentic only if the first authentication token and the first hash digest are the same;
and wherein the step of authenticating the message further includes the steps of:
(o) inputting at least a portion of the message and secret information related to the message into a second hash function to generate a second hash digest;
(p) comparing the second hash digest with a second authentication token included in the message, wherein the message is authentic only if the second authentication token and the second hash digest are the same.

59. The method of claim 58, wherein at least a portion of the decryption-key is also included as input into the first hash function.

60. The method of claim 58, wherein at least a portion of the decryption-key-material is also included as input into the first hash function.

61. The method of claim 56, prior to step (a), further including the steps of:
(h) receiving from the headend a stream of packets, the stream of packets including packets carrying a portion of the digital service and an entitlement control message, wherein the entitlement control message is associated with a specific set of packets of the stream of packets; and
(i) recording the stream of packets carrying the digital service in the storage device.

62. The method of claim 61, prior to step (i), further including the steps of:
(j) determining whether the settop is entitled to access the specific set of packets; responsive to determining the settop is entitled to access the specific set of packets, further including the steps of:
(k) generating the decryption-key from the entitlement control message and a second key;
(1) providing at least a portion of the decryption-key and secret information to a hash function to generate an authentication token;
(m) generating the decryption-key-material by encrypting the decryption-key with the first key;
(n) including the decryption-key-material and the authentication token in a decryptor;
(o) providing the decryptor and the specific set of packets to the storage device; and
(p) repeating steps (i) through (o) until the service is completed.

63. The method of claim 62, wherein step (n) further includes the step of including temporal information in the decryptor, wherein the temporal information defines an entitled time span over which the settop is entitled to access the recorded service.

64. The method of claim 61, wherein step (i) further includes recording the entitlement control message with the digital service in the storage device, wherein the stored entitlement control message is a decryptor of the plurality of decryptors.

65. The method of claim 56, wherein step (c) further includes the step of:
decrypting the decryption-key-material with the first key.

66. The method of claim 56, wherein step (c) further includes the step of:
encrypting the decryption-key-material with the first key.

67. The method of claim 56, wherein the step of determining whether the settop is entitled to access the recorded service further includes the steps of:
(h) generating a challenge;
(i) providing the challenge to both a memory of the settop and a challenge message, wherein the challenge is stored in the memory and included in the challenge message;
(j) transmitting the challenge message to the headend;
(k) receiving a reply challenge message from the headend, the reply challenge message having a reply challenge included therein;
(l) comparing the reply challenge with the stored challenge, wherein the settop is entitled only if the reply challenge and the stored challenge are the same.

68. The method of claim 67, further including the step of:
(m) authenticating the reply challenge message, wherein the settop is entitled only if the reply challenge message is authentic.

69. The method of claim 67, further including the step of:
(m) comparing a reference time with the specified time, wherein the reply challenge message includes the reference time, and the settop is only entitled if the specified time is later than or equal to the reference time.

70. The method of claim 67, wherein the challenge is a random number.

71. The method of claim 56, wherein responsive to determining the settop is not entitled to access the specific set of packets, further including the steps of:
(h) generating a challenge;
(i) providing the challenge to both a memory of the settop and a challenge message, wherein the challenge is stored in the memory and included in the challenge message;
(j) transmitting the challenge message to headend, wherein the challenge message further includes a first set of rights of the settop to the recorded service;
(k) receiving a reply challenge message, the reply challenge message having a second set of rights of the settop to the recorded service included therein;
(l) authenticating the reply challenge message; responsive to the reply challenge message being authentic, further including the steps of:
(m) further determining whether the settop is now entitled to access the specific set of packets using the second set of rights;
(n) responsive to the settop being entitled, implementing steps (e), (f) and (g).

72. The method of claim 71, wherein step (l) further includes the steps of:
(o) decrypting at least a portion of the content of the reply challenge message with a second key;
(p) providing at least a portion of the content of the reply challenge message and a secret to a hash function to generate a hash digest;
(q) coding an authentication token included in the reply challenge message with a public key of a public key-private key pair, the public key belonging to the headend; and
(r) comparing the hash digest with the coded authentication token, wherein the reply challenge message is authentic only if the hash digest and the coded authentication token are the same.

73. The method of claim 56, wherein step (d) further includes the step of:
(h) determining whether the specified time is within an entitled time span, wherein the settop is only entitled if the specified time is within the entitled time span.

74. A Personal Service Recorder (PSR) in a subscriber television system that transmits digital services from a headend to the PSR, the PSR for providing a user with a recorded digital service, the PSR comprising:
a storage device having a digital service carried in a plurality of packets and a plurality of decryptors stored therein, each decryptor associated with a set of packets of the plurality of packets, wherein each set of packets make up a portion of the digital service;
a cryptographic device in communication with the storage device adapted to decrypt a given set of packets with a given control word;
a memory having entitlements to digital services stored therein;
a processor in communication with the decryptor and the memory, the processor adapted to receive a user input and responsive thereto determine whether the PSR is entitled to access the given set of packets, wherein responsive to the PSR being entitled to access the given set of packets, the processor processes a given decryptor of the plurality of decryptors with a first key to generate the control word and provides the control word to the cryptographic device.

75. The PSR of claim 74, wherein the memory and the processor are packaged in tamper resistant packaging.

76. The PSR of claim 74, wherein the memory is accessible only to the processor, and a private key of a public key-private key pair belonging to the PSR is stored in the memory.

77. The PSR of claim 74, wherein the given decryptor includes an authentication token, and the processor determines whether the decryptor is authentic using the authentication token, and the control word is provided to the decryptor only if the decryptor is authentic.

78. The PSR of claim 77, wherein the decryptor includes key-decryption-material and a key identifier, and responsive to the decryptor being authentic, the processor retrieves the first key from the memory using the key identifier included in the decryptor and processes the key-decryption-material with the first key to generate the control word.

79. The PSR of claim 78, wherein the control word is generated by decrypting the key-decryption-material with the first key.

80. The PSR of claim 78, wherein the control word is generated by encrypting the key-decryption-material with the first key.

81. The PSR of claim 74, wherein the processor is further adapted to receive a time-message having a specific time included therein and determine whether the specific time is within a given time span, wherein the control word is provided to cryptographic device only if the specific time is within the time span.

82. The PSR of claim 74, further including:
an input port in communication with the headend and the storage device, the input port receiving a stream of packets carrying a given digital service and entitlement control messages associated with the given digital service, and wherein the processor is further adapted to determine whether the PSR is entitled to record the given digital service, and responsive to the PSR being entitled to access the given digital service, the processor generates the control word using a second key, encrypts the control word with the first key, thereby converting the control word into key-decryption-material, and includes the key-decryption-material in a decryptor.

83. The PSR of claim 74, wherein the processor is further adapted to generate a challenge and an authentication token, the processor includes the challenge and the authentication token in a secure message, wherein the secure message is transmitted to the headend.

84. The PSR of claim 83, wherein the authentication token is a digitally signed hash digest, which was signed by the processor using a private key of a public key-private key pair belonging to the PSR, the hash digest is an output of a hash function having at least a portion of the challenge as an input.

85. The PSR of claim 83, wherein processor is further adapted to authenticate a reply message, wherein control word is only provided to the cryptographic device responsive to the reply message being authentic.

86. The PSR of claim 83, wherein the reply message includes a reference time, and the processor is further adapted to receive a time-message having a specific time included therein and determine whether the specific time is earlier than the reference time, and the control word is provided to cryptographic device only if the specific time is equal to or later than the reference time.

87. The PSR of claim 86, wherein the given decryptor includes temporal information that defines a time span, and the processor is adapted to determine whether the specific time is within the given time span, wherein the control word is provided to cryptographic device only if the specific time is within the time span.

88. The PSR of claim 83, wherein the secure message is transmitted to the headend responsive to the PSR not being entitled to access the given set of packets.

89. A method of providing a recorded digital service to a subscriber in a subscriber television system, the method implemented in a settop in communication with a headend of the subscriber television system, the method comprising the steps of:
recording in a storage device a plurality of decryptors and a digital service transmitted from the headend to the settop, wherein the digital service is carried in a plurality of packets, each decryptor of the plurality of decryptors is associated with a set of packets of the plurality of packets, and each decryptor includes decryption-key-material to decrypt the set of packets associated with the decryptor;
receiving user input for accessing the recorded digital service;
receiving from the headend a time-message that specifies a time;
retrieving from the storage device a given decryptor of the plurality of decryptors;
processing the decryption-key-material included in the given decryptor with a first key to generate a control word therefrom;
inputting at least a portion of the time-message into a first hash function to generate a first digest;
processing a first authentication token included in the time-message with a public key of a public key-private key pair;
comparing the first digest with the processed first authentication token, wherein responsive to the first digest and the processed first authentication token being the same, the time-message is authentic;
inputting at least a portion of the decryptor into a second hash function to generate a second digest;
comparing the second digest with a second authentication token included in the decryptor, wherein responsive to the second digest and the second authentication token being the same, the decryptor is authentic; and
responsive to both the decryptor and the time-message being authentic, further including the steps of:
determining whether the specified time is within a given entitled time span;
determining whether the settop is entitled to access the recorded digital service by using at least a portion of the given decryptor;
responsive to both determining the settop is entitled to access the digital service and determining the settop is entitled to access the recorded digital service, further including the steps of:
decrypting the set of packets associated with the decryptor using the control word; and
determining whether the entire recorded digital service has been accessed.

90. A Personal Service Recorder (PSR) for providing a recorded digital service to a subscriber in a subscriber television system that transmits digital services from a headend to the PSR, the PSR comprising:
an input port receiving a stream of packets, the stream of packets including packets carrying a digital service and packets carrying time-messages, each time-message having a specific time and an authentication token included therein;
a storage device in communication with the input port, the storage device adapted to store the packets carrying the digital service and a plurality of decryptors therein, each decryptor associated with a set of packets carrying the digital service, each decryptor having decryption-key-material and an authentication token, the decryption-key-material for generating a control word for decrypting a particular set of packets carrying the digital service;
a cryptographic device in communication with the storage device adapted to decrypt a given set of packets with a given control word;
a memory having entitlements to digital services, a first key, and a public key of a public key-private key pair stored therein;
a processor in communication with the input port, the cryptographic device and the memory, the processor adapted to input at least a portion of a given time-message into a first hash function to generate a first hash, process the authentication token of the time-message with the public key, compare the first hash digest with the processed authentication token, wherein the given time-message is authentic only if the first hash digest and the processed first authentication token are the same, the processor further adapted to input at least a portion of a given decryptor of the plurality of decryptors into a second hash function to generate a second hash, compare the second hash digest with a second authentication token included in the given decryptor, wherein the given decryptor is authentic only if the second hash digest and the second authentication token are the same, the processor further adapted to determine whether the specific time included in the time-message is within an entitled time span and determine whether the PSR is entitled to access the given set of packets using the entitlements stored in the memory, the processor further adapted to generate the given control word using the first key and the decryption-key-material included in the given decryptor and provide the given control word to the cryptographic device, wherein the processor provides the given control word to the cryptographic device only if the time-message and the decryptor are authentic and the specific time is within the entitled time span and the PSR is entitled to access the given set of packets.
